(19) United States
(12) Patent Application Publication
(10) Pub. No.: US 2023/0162241 A1
(43) Pub. Date: May 25, 2023

(54) SYSTEMS AND METHODS FOR CONTEXTUAL GENERATION OF GIFT OBJECTS

(71) Applicant: Loop Commerce, Inc., Stamford, CT (US)

(72) Inventors: Gabriel Saunkeah, Berkeley, CA (US); Shane Parrish, Menlo Park, CA (US); Michael Hendrickson, Menlo Park, CA (US); Si Hao Chua, Menlo Park, CA (US)

(21) Appl. No.: 18/055,456

(22) Filed: Nov. 15, 2022

Related U.S. Application Data
(60) Provisional application No. 63/282,325, filed on Nov. 23, 2021.

(51) Int. Cl. G06Q 30/02; G06Q 30/06

(52) U.S. Cl. CPC G06Q 30/0276; G06Q 30/0277; G06Q 30/0643

(57) ABSTRACT

Systems and methods for generating gift advertisements based on contextual signals obtained from user devices and from various retailer systems through which products are offered that can serve as the basis for a gift are provided. A gifting distribution system detects access to a website. The access is associated with a user. The system identifies contextual signals based on content presented on the website and data associated with the user. The system obtains product information for products that can be presented in a gift advertisement within the website. Further, the system generates contextual information that can be presented in the advertisement based on the contextual signals and the product information. The gift advertisement is generated using the contextual information and is presented to the user through the website. If the user selects the advertisement, the user is presented with tailored options for generating a gift from the products.

### CROSS-REFERENCE TO RELATED APPLICATIONS

The present patent application claims the priority benefit of U.S. provisional patent application No. 63/282,325 filed Nov. 23, 2021, the disclosures of which are incorporated by reference herein.

### FIELD

The present disclosure relates to systems and methods for generating gift advertisements based on contextual signals obtained from user devices and from various retailer systems through which products are offered that can serve as the basis for a gift.

### SUMMARY

Disclosed embodiments may provide a framework to automatically generate contextual gift advertisements based on contextual signals obtained from user devices and from various retailer systems through which products are offered that can serve as the basis for a gift. According to some embodiments, a computer-implemented method is provided. The computer-implemented method comprises detecting access to a website. The access to the website is associated with a user. The computer-implemented method further comprises identifying one or more contextual signals. The one or more contextual signals are identified based on content presented on the website and data associated with the user. The computer-implemented method further comprises obtaining product information associated with one or more products. The computer-implemented method further comprises generating contextual information using the one or more contextual signals and the product information. The contextual information includes one or more messages corresponding to the one or more contextual signals and the product information. The computer-implemented method further comprises generating a gift advertisement. The gift advertisement is generated using the product information and the contextual information. Further, the gift advertisement includes the one or more messages and a link to a page for generating a gift from the one or more products. The computer-implemented method further comprises presenting the gift advertisement. When the user selects the gift advertisement, the user is redirected to the page to present one or more options for generating the gift from the one or more products. Further, the one or more options are generated based on the one or more contextual signals and the contextual information.

In some embodiments, the page is a product detail page associated with the one or more products. The product detail page is provided by a retailer that makes available the one or more products.

In some embodiments, the one or more options include a set of delivery options for the gift. The set of delivery options are identified based on the one or more contextual signals.

In some embodiments, the product information includes images of the one or more products, pricing details of the one or more products, and customization options associated with the one or more products.

In some embodiments, the contextual signals are associated with an event date. The contextual information incorporates the event date.

In some embodiments, the contextual signals include clickstream data associated with the user, search data associated with the user, purchase data associated with the user, and user profile data associated with the user.

In some embodiments, the contextual signals are obtained through a cookie implemented on a user device associated with the user.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which one or more options for generating a gift object are presented based on selection of an advertisement and contextual information corresponding to a user device and to an advertisement selected for generating the gift object in accordance with at least one embodiment;

FIG. 2 shows an illustrative example of an environment in which a gifting distribution system generates one or more advertisements using product information from retailer systems and contextual signals garnered from a user device and the retailer systems in accordance with at least one embodiment;

FIG. 3A shows an illustrative example of an environment in which one or more options for generating a gift object are provided to a user device based on contextual information corresponding to selection of an advertisement and to the user device in accordance with at least one embodiment;

FIG. 3B shows an illustrative example of an environment in which a machine learning system implements and continuously updates machine learning algorithms used to generate contextual information for the creation of gift advertisements and to generate the one or more options for generating a gift object in accordance with at least one embodiment;

FIG. 4 shows an illustrative example of an environment in which contextual signals garnered from search terms submitted by a user and from product details obtained from one or more retailers is used to generate one or more advertisements that are presented in accordance with at least one embodiment;

FIGS. 5A-5B show an illustrative example of an environment in which contextual information from an article and from product details obtained from one or more retailers is used to generate an advertisement for generation of a gift object such that selection of the advertisement results in presentation of a product detail page for generation of the gift object in accordance with at least one embodiment;

FIGS. 6A-6B show an illustrative example of an environment in which generation of a gift object is performed upon selection of an option to generate the gift object presented through a retailer website in accordance with at least one embodiment;

FIG. 7 shows an illustrative example of an environment in which contextual information from a calendar associated with a user is processed to present the user with an option to generate a gift object for a particular recipient in accordance with at least one embodiment;

FIG. 8 shows an illustrative example of an environment in which contextual information associated with content presented in a video or other media is used to generate and present an option to generate a gift object in accordance with at least one embodiment;

FIG. 9 shows an illustrative example of an environment in which contextual information associated with a user and with a service provider are used to generate an advertisement for generation of a gift object in accordance with at least one embodiment;

FIG. 10 shows an illustrative example of an environment in which contextual information obtained from one or more e-mail messages are used to generate an advertisement for generation of a gift object in accordance with at least one embodiment;

FIGS. 11A-11F show an illustrative example of an environment in which a user device is used to interact with an advertisement presented at a point-of-sale to generate a gift object for delivery to a recipient in accordance with at least one embodiment;

FIGS. 12A-12E show an illustrative example of an environment in which a recipient of a gift object interacts with the gift object through a user device to request delivery of a particular gift in accordance with at least one embodiment;

FIG. 13 shows an illustrative example of a process for using contextual information to generate and present a gift advertisement in accordance with at least one embodiment;

FIG. 14 shows an illustrative example of a process for using contextual information to identify and present one or more gifting options for creation and delivery of a gift object in accordance with at least one embodiment; and

FIG. 15 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically generate contextual gift advertisements based on contextual signals obtained from user devices and from various retailer systems through which products are offered that can serve as the basis for a gift. Through this framework, a gifting distribution system can automatically and dynamically process contextual signals when a user accesses a website. These contextual signals may be identified based on content presented on the website and data associated with the user. Based on these contextual signals, the gifting distribution system can dynamically generate and present, on the website, a gift advertisement that includes contextual information associated with the received contextual signals, one or more gift ideas corresponding to the contextual signals, and a link to a page for generating a gift based on the one or more gift ideas.

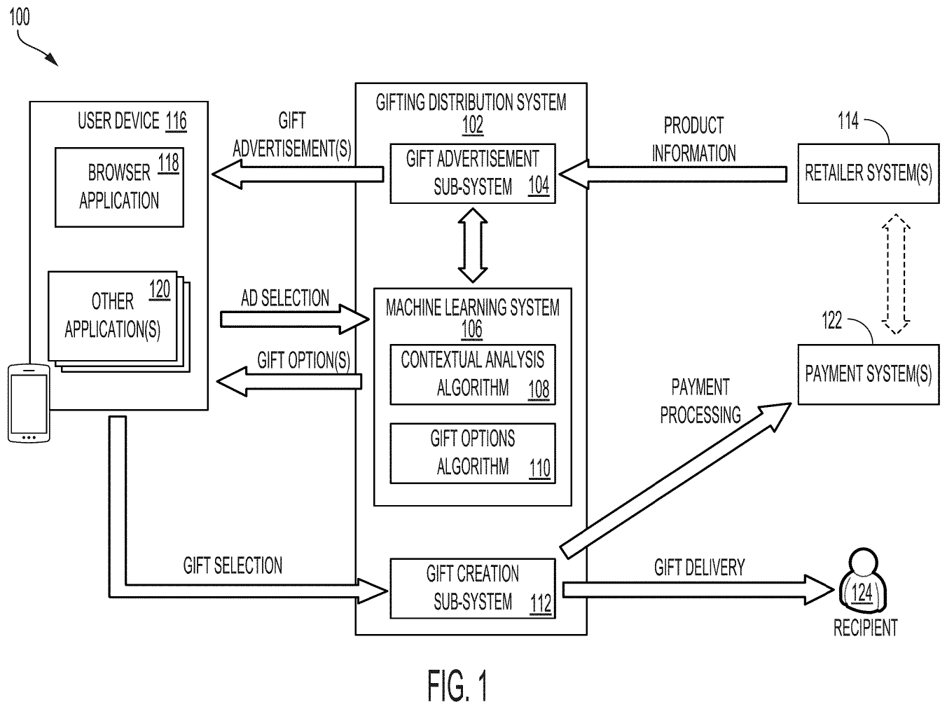

FIG. 1 shows an illustrative example of an environment 100 in which one or more options for generating a gift object are presented based on selection of an advertisement and contextual information corresponding to a user device 116 and to an advertisement selected for generating the gift object in accordance with at least one embodiment. In the environment 100, a gifting distribution system 102 presents, to a user device 116 via a browser application 118 and/or one or more other applications 120 implemented on the user device 116, one or more gift advertisements that may be used to request creation of a gift object that may be delivered to a particular recipient 124. For instance, if a user of the user device 116, through a browser application 118, navigates to a particular website, the gifting distribution system 102 may generate and present one or more gift advertisements to the user through the website. Similarly, other applications 120 implemented on the user device 116 may be configured to present advertisements from other entities, such as the gifting distribution system 102. Thus, as the user engages with these other applications 120, the gifting distribution system 102 may present one or more gift advertisements to the user.

In an embodiment, the gifting distribution system 102 includes a gift advertisement sub-system 104 that is configured to generate gift advertisements that may be presented to users. The gift advertisement sub-system 104 may be implemented on a computing system or other system (e.g., server, etc.) of the gifting distribution system 102. The gift advertisement sub-system 104 may automatically generate one or more gift advertisements that may be presented to the user via the browser application 118 or any other applications 120 based on data from various sources. For example, if the user navigates to a particular website using a browser application 118, the gift advertisement sub-system 104 may generate a gift advertisement that may be presented to the user via a display advertisement within the website (e.g., banner advertisement, responsive advertisement, retargeting advertisement, native advertisement, social advertisement, discovery advertisement, etc.). As another example, if the user submits a search query via a search engine, the gift advertisement sub-system 104 may generate a gift advertisement that may be presented alongside any search results provided by the search engine.

In an embodiment, the gift advertisement sub-system 104 can use a cookie to obtain data about the user that may be used to generate a gift advertisement that is tailored to the user. Through the cookie, the gift advertisement sub-system 104 may collect clickstream data (e.g., data corresponding to webpages the user has accessed), search data (e.g., search terms submitted by the user through one or more search engines, etc.), purchase data (e.g., purchase histories from one or more online retailers, etc.), user profile data (e.g., user profiles from social networking websites, user profiles from multimedia website, etc.), and the like. This data may be used to generate contextual gift advertisements that may be relevant to the user and that may be conducive in allowing the user to purchase and deliver a gift for a particular recipient. As an illustrative example, if the user submits, via a search engine, the search terms “best gifts for Mother's Day,” the gift advertisement sub-system 104 may utilize this search data to determine that the user is interested in purchasing and delivering a gift to a recipient in anticipation of Mother's Day. Accordingly, the gift advertisement sub-system 104 may generate a contextual gift advertisement that provides the user with one or more gifting options for purchasing and delivering a gift to the recipient for Mother's Day. The gift advertisement may include one or more references to the search terms provided by the user. For example, this gift advertisement may make reference to Mother's Day such that the user may be enticed to select the gift advertisement and purchase a gift for the intended recipient.

As another example, if the user, through the browser application 118 or other application 120 navigates to a particular website, the gift advertisement sub-system 104 may evaluate the particular website for one or more contextual signals that may be used to generate a contextual gift advertisement that may be presented to the user on the website. For example, if the user navigates to a website that includes a news article that was updated at or near Mother's Day, the gift advertisement sub-system 104 may automatically, and in real-time, determine that a gift advertisement may be presented that provides the user with one or more gifting options for purchasing and delivering a gift to a recipient for Mother's Day. The gift advertisement sub-system 104 may include, in the gift advertisement, one or more contextual elements that are related to the contextual signals detected by the gift advertisement sub-system 104. For example, the gift advertisement may include a caption such as “Mother's Day Is Almost Here!,” which may inform the user that Mother's Day is approaching. Further, the gift advertisement sub-system 104, through the gift advertisement, may provide the user with one or more gift options that may be purchased and delivered to a recipient. For example, the gift advertisement may include one or more images or other product details corresponding to different products that may be purchased and delivered to a recipient as a gift from the user.

In an embodiment, the gift advertisement sub-system 104 obtains product information from one or more retailer systems 114 to provide this product information to users through gift advertisements that are presented to the user via the browser application 118 and/or other applications 120 implemented on the user device 116. For instance, if the gift advertisement to be generated for the user corresponds to a particular retailer and/or to one or more particular products, the gift advertisement sub-system 104 may generate a gift advertisement that includes one or more elements associated with the retailer and/or the one or more particular products derived from the product information. As an illustrative example, the gift advertisement sub-system 104 may display, within a gift advertisement, a logo, trademark, or other distinguishing feature that uniquely identifies the retailer through which a gift may be purchased and delivered. Additionally, the gift advertisement sub-system 104 may provide, through the gift advertisement, images of one or more products that may be purchased and delivered to a recipient, descriptions of the one or more products, pricing information associated with the one or more products, and the like.

In an embodiment, the product information from the one or more retailer systems 114 can be obtained in real-time when the gift advertisement is to be generated. For instance, when a user accesses a particular website or otherwise interacts with one or more applications through which gift advertisements may be presented, the gift advertisement sub-system 104 may query the one or more retailer systems 114 to obtain product information related to one or more products that may be presented as gifting options within the gift advertisement. In some instances, the gift advertisement sub-system 104 may maintain a repository that includes product details for various products that may be presented as gifting options. These product details may have been provided by one or more retailers in order to advertise the various products sold by these one or more retailers. Further, the product details may have been previously obtained in response to queries triggered in response to other user interactions (e.g., of the present user and/or other users) on a website and/or on other applications implemented on user devices.

In an embodiment, if the gift advertisement sub-system 104 determines that a gift advertisement is to be presented to the user, the gift advertisement sub-system can automatically query the one or more retailer systems 114 to determine whether any new product information is available for one or more products to be presented as gifting options. For instance, if the gift advertisement sub-system 104 identifies, from the aforementioned repository, one or more products that may be presented as gifting options to the user via a gift advertisement, the gift advertisement sub-system 104 may automatically query the one or more retailer systems 114 associated with these one or more products to determine whether new or updated product information is available for these one or more products. This new or updated product information may include updated images of the one or more products, updated pricing details of the one or more products (e.g., sales prices, discounts, new manufacturer's suggested retail prices (MSRPs), etc.), updated sizing or color options for the one or more products, and the like. The gift advertisement sub-system 104 may update the repository to incorporate this new or updated product information such that the gift advertisements presented may include up-to-date information corresponding to the one or more products being offered as gifting options.

In some instances, the one or more retailer systems 114 may automatically provide any updates corresponding to the one or more products that may be presented as gifting options by the gift advertisement sub-system 104 without requiring a query from the gift advertisement sub-system 104. For example, as a retailer updates the product information for one or more products that may be offered by the gift advertisement sub-system as gifting options to users, the retailer may automatically push this updated product information to the gift advertisement sub-system 104. In some instances, the gift advertisement sub-system 104 may expose one or more application programming interfaces (APIs), through which the retailer may push the updated product information to the gift advertisement sub-system 104. The gift advertisement sub-system 104 may store this updated product information in the aforementioned repository such that, when a gift advertisement is to be presented to the user, the gift advertisement sub-system 104 may present the updated product information through the gift advertisement.

In an embodiment, the gift advertisement sub-system 104 provides contextual signals obtained from the user device 116 (such as through the browser application 118 and/or other applications 120), the website or other content accessed by the user, and any other information garnered from the user (such as through the cookie) and/or one or more retailer systems 114 to a machine learning system 106 to determine the contextual information that may be presented to the user through a gift advertisement. The machine learning system 106 may be implemented on a computing system or other system (e.g., server, etc.) of the gifting distribution system 102. Alternatively, the machine learning system 106 may be implemented as an application or other executable process on a computer system implemented by the gifting distribution system 102. The machine learning system 106 may comprise a contextual analysis algorithm 108 that is configured to analyze the contextual signals obtained from the user device 116, the website or other content accessed by the user, and any other information garnered from the user and/or one or more retailer systems 114 to identify the contextual information that may be presented to the user in the gift advertisement.

The contextual analysis algorithm 108 may be trained using supervised learning techniques to generate or otherwise identify contextual information that may be presented to a user through a gift advertisement based on the obtained contextual signals and other information from the user device 116 and the one or more retailer systems 114. For instance, the contextual analysis algorithm 108 may be trained using sample contextual signals, contextual information generated based on these contextual signals and used to generate gift advertisements, and feedback provided with regard to the contextual information presented within these gift advertisements. The sample contextual signals may include user data that may be obtained via cookies (e.g., clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments, and the like. The contextual information may include any information that may be provided to a user based on the obtained contextual signals. For example, if a contextual signal includes a data on or near a holiday, the contextual information may include text, images, objects or other information associated with the holiday.

As an illustrative example of the training of the contextual analysis algorithm 108, an evaluator of the contextual analysis algorithm 108 (e.g., an administrator of the gifting distribution system 102, independent party introduced to perform such evaluations, etc.) may review the contextual information generated by the contextual analysis algorithm 108 to determine whether the contextual information accurately corresponds to the received contextual signals. In some instances, an evaluator may act as a user or other entity that utilizes their user device to access a website or otherwise utilize an application through which gift advertisements may be presented. For example, the evaluator may determine whether the contextual information provided in a gift advertisement corresponds to the contextual signals and other information from a user device and the one or more retailer systems 114. As an illustrative example, if the contextual signals and other information correspond to Mother's Day and an urgent need to purchase a gift for a recipient for Mother's Day, the evaluator may determine whether the resulting gift advertisement includes contextual information related to Mother's Day and expresses to the user that they should not delay in purchasing a gift for Mother's Day (e.g., “Mother's Day is almost here! It's not too late to get her that gift she deserves!,” etc.). If the resulting gift advertisement does not include contextual information related to Mother's Day and/or does not express an urgent call to purchase a gift (e.g., “Father's Day is weeks away. Start thinking about the special gift for him!,” etc.), the evaluator may determine that the contextual analysis algorithm 108 is not producing accurate results. Otherwise, if the evaluator determines that the resulting gift advertisement does provide the appropriate contextual information based on the submitted input, the evaluator may determine that the contextual analysis algorithm 108 is producing accurate results. Based on this feedback, the contextual analysis algorithm 108 may be re-trained and/or reinforced to provide accurate or improved contextual information that can be added to gift advertisements presented to users.

In an embodiment, the contextual analysis algorithm 108 can be further trained in real-time as gift advertisements are presented to different users as these different users utilize their user devices to access one or more websites or otherwise utilize an application through which gift advertisements may be presented. For instance, the machine learning system 106 may, in real-time, obtain feedback from a user corresponding to their interaction with the gift advertisement through a website or application. As an illustrative example, if a user interacts with a presented gift advertisement (e.g., selects the gift advertisement, clicks on the gift advertisement, etc.), the machine learning system 106 may determine that the user found the gift advertisement to be appealing or enticing. This may serve as an indication that the gift advertisement included the appropriate contextual information based on the contextual signals and other information from the user's user device and the one or more retailer systems 114. The machine learning system 106 may use this feedback to reinforce the contextual analysis algorithm 108 such that, for similar contextual signals and other information associated with the user and the one or more retailer systems 114, the contextual analysis algorithm 108 is more likely to produce similar contextual information that may be included in gift advertisements. As another illustrative example, if a user fails to interact with a presented gift advertisement or otherwise expresses that the presented gift advertisement is not relevant (e.g., the user selects an option to hide the presented gift advertisement, the user provides negative feedback with regard to the presented gift advertisement, etc.), the machine learning system 106 may evaluate the presented gift advertisement and the contextual signals obtained from the user device and the one or more retailer systems 114 to determine whether the presented gift advertisement included accurate contextual information. If the presented gift advertisement did not include accurate contextual information, the machine learning system 106 may re-train the contextual analysis algorithm 108 to better identify the appropriate contextual information given similar contextual signals. Alternatively, if the presented gift advertisement did include accurate contextual information, the machine learning system 106 may dynamically re-train the contextual analysis algorithm 108 to generate contextual information that may be more enticing to users for similar contextual signals.

The machine learning system 106 may provide the contextual information generated by the contextual analysis algorithm 108 to the gift advertisement sub-system 104. The gift advertisement sub-system 104, using the contextual information from the contextual analysis algorithm 108 and the product information from one or more retailer systems 114, may generate a contextual gift advertisement that is presented to the user via the browser application 118 or other application 120 being utilized by the user. A contextual gift advertisement may include various elements that allow a user to review the proposed gift and to select the contextual gift advertisement in order to access a product detail page or a standalone page associated with the gifting distribution system 102 in order to purchase and deliver a gift to an intended recipient. For example, a contextual gift advertisement may include an image, digital video, or other visual element associated with one or more products that may be available for purchase and delivery as a gift. Additionally, the contextual gift advertisement may include contextual information that may be relevant to the user based on contextual signals received by the gift advertisement sub-system 104. For example, if the contextual gift advertisement is being presented within a small window of time prior to Thanksgiving, the contextual gift advertisement may include contextual information associated with Thanksgiving and convey a sense of urgency in purchasing a gift (e.g., “Thanksgiving is around the corner! Be sure to gobble up these savings for your special someone!”). The contextual gift advertisement may further include one or more interaction elements that may be selected to access a product detail page or a standalone page associated with the gifting distribution system 102 in order to purchase and deliver a gift to an intended recipient. For example, the one or more interaction elements may include a graphical user interface (GUI) button that provides a signal to the user to select the button in order to purchase a gift for a recipient. The GUI button, for example, may include text such as “Gift Now!,” “Get Started!,” “Get Him a Gift!,” or other similar text that may be indicative of a gift creation process.

In an embodiment, the gift advertisement sub-system 104 can present a contextual gift advertisement at a point-of-sale (e.g., kiosk, store, office, etc.) associated with a retailer. For instance, rather than using contextual signals from the user device 116, the gift advertisement sub-system 104 may obtain contextual signals from a retailer system 114 associated with the point-of-sale. These contextual signals may include the current date, any sale/discount information for products offered at the point-of-sale, sales information or records corresponding to sales previously conducted at the point-of-sale, and the like. These contextual signals may be provided to the machine learning system 106 to allow the contextual analysis algorithm 108 to generate contextual information that may be included in a gift advertisement to be presented at the point-of-sale.

At the point-of-sale, the gift advertisement sub-system 104 may present a contextual gift advertisement that includes contextual information that may provide an impetus to a user to purchase and deliver a gift electronically from the point-of-sale. For example, if the contextual gift advertisement is being presented at the point-of-sale within a small window of time prior to Mother's Day, the contextual information may indicate that users still have time to purchase a gift for that special someone for Mother's Day. Once Mother's Day has passed, the gift advertisement sub-system 104 may automatically, and dynamically, update the gift advertisement to provide new contextual information (e.g., contextual information related to Mother's Day may be promptly replaced automatically with contextual information related to Father's Day or other upcoming holiday, etc.).

The contextual gift advertisement presented at a point-of-sale may further include one or more interactive elements that may allow a user to access a product detail page or a standalone page associated with the gifting distribution system 102 in order to purchase and deliver a gift to an intended recipient. For example, for each image corresponding to a possible gift that may be purchased and delivered to a recipient, the contextual gift advertisement may include a code (e.g., barcode, Quick Response code, etc.) that may be scanned using a user device 116 to access a product detail page or standalone page corresponding to the selected gift. If the user, using its user device 116, scans the code, the user device 116 may execute a browser application 118 or other application 120 to access the product detail page or standalone page corresponding to the selected gift.

In an embodiment, if the user selects the contextual gift advertisement, the user may be redirected to a product detail page or standalone page corresponding to the contextual gift advertisement. If the user is redirected to a product detail page, the user may be presented with one or more gift options provided by the retailer system 114 corresponding to the selected contextual gift advertisement. For example, the product detail page may be include product information associated with each of the gift options being provided. This product information may include sizing options, color options, customization options, MSRP, actual sales price, shipping costs, estimated tax, and the like. In an embodiment, the product detail page can further include one or more gift options provided by the gifting distribution system 102 along with the product information. The one or more gift options may include delivery options available for delivery of the gift to a recipient (e.g., digital delivery options, physical delivery options, etc.). Further, the one or more gift options may include different gifting services, such as gift wrapping, specialized cards or notes, and the like.

In an embodiment, the one or more gift options that may be presented on the product detail page may be identified using a gift options algorithm 110 of the machine learning system 106. The gift options algorithm 110 may be dynamically trained to analyze the contextual information generated by the contextual analysis algorithm 108 and presented in the gift advertisement, as well as any new information garnered from the user device 116 and/or a retailer system 114 associated with the product detail page, to generate one or more gift options that may be presented to the user via the product detail page. The new information garnered from the user device 116 may include user data that may be obtained after presentation of the gift advertisement. This user data may be obtained via cookies (e.g., clickstream data, search data, purchase data, user profile data, etc.), data corresponding to content presented on a website or application, data obtained from e-mails or social media posts/comments, and the like. The new information garnered from the retailer system 114 may include messages transmitted by the retailer system 114 to users related to the products being offered for gifting, shipping cutoff dates, sale/discount cutoff dates, and the like.

The gift options algorithm 110 may be dynamically trained using supervised learning techniques to generate or otherwise identify gift options that may be presented to a user through a product detail page or standalone page corresponding to the contextual gift advertisement based on the contextual information presented in the gift advertisement, any new contextual signals, and other new information from the user device 116 and the retailer system 114 providing the one or more products available for gifting. For instance, gift options algorithm 110 may be trained using sample contextual information from gift advertisements, contextual signals from user devices and retailer systems 114, gift options generated based on the contextual information and contextual signals used to generate the gift options, and feedback provided with regard to these gift options.

As an illustrative example of the training of the gift options algorithm 110, an evaluator of the gift options algorithm 110 (e.g., an administrator of the gifting distribution system 102, independent party introduced to perform such evaluations, etc.) may review the gift options generated by the gift options algorithm 110 to determine whether the gift options accurately correspond to the received contextual information and contextual signals from the user device 116 and retailer systems 114. In some instances, an evaluator may act as a user or other entity that utilizes their user device to access a product detail page through which one or more gift options may be presented. For example, the evaluator may determine whether the gift options presented in a product detail page corresponds to the contextual signals and contextual information from the user device 116 and the one or more retailer systems 114. As an illustrative example, if the contextual signals correspond to the user having a short amount of time to provide a gift to a recipient, the evaluator may determine whether the provided gift options correspond to expedited shipping of the gift and/or digital delivery of the gift. As another illustrative example, if the contextual signals and contextual information correspond to a recipient's upcoming birthday, the evaluator may determine whether the provided gift options include an option for gift wrapping, an option for including a birthday card with the gift, options corresponding to shipping methods based on the proximity to the actual birthday, and the like.

As an illustrative example, if the contextual signals and contextual information correspond to Mother's Day and an urgent need to purchase a gift for a recipient for Mother's Day, the evaluator may determine whether the resulting gift options include at least an option for expedited or digital shipping of the gift and for including a Mother's Day card or note with the gift. If the resulting gift options do not include options for expedited/digital shipping of the gift and/or for including a Mother's Day card or note with the gift, the evaluator may determine that the gift options algorithm 110 is not producing the desired gift options for delivery of the gift. Otherwise, if the evaluator determines that the provided gift options do correspond to the received contextual signals and information, the evaluator may determine that the gift options algorithm 110 is producing accurate results. Based on this feedback, the gift options algorithm 110 may be re-trained and/or reinforced to provide accurate or improved gift options that can be presented to users within a product detail page.

In an embodiment, the machine learning system 106 can dynamically re-train or otherwise update the gift options algorithm 110 in real-time as each user interacts with their respective one or more gift options presented on the product detail page. As an illustrative example, if a particular user does not select any of the one or more gift options presented to the user through the product detail page (e.g., the user exits the product detail page without making a selection, the user manually creates one or more options for the gift, etc.), the machine learning system 106 may use this as negative feedback corresponding to the one or more gift options generated by the gift options algorithm 110. For instance, the machine learning system 106, based on this negative feedback, may determine that the presented one or more gift options did not correspond to the received contextual signals and information. For instance, if the user accessed the product detail page through selection of a gift advertisement that includes contextual information corresponding to Mother's Day and none of the provided gift options were selected as a result of these gift options failing to provide options for expedited or digital shipping of the gift and for including a Mother's Day card or note with the gift, the machine learning system 106 may determine that the gift options algorithm 110 has failed to provide appropriate gift options given the contextual information specified in the selected gift advertisement and the contextual signals from the user and the one or more retailer systems 114. Accordingly, the machine learning system 106 may dynamically re-train the gift options algorithm 110 such that, for similar contextual information and signals, the gift options algorithm 110 may be less likely to provide the one or more gift options previously presented. In some instances, if the user manually created one or more gift options for the gift through the product detail page, the machine learning system 106 may dynamically re-train the gift options algorithm 110 such that, for similar contextual information and signals, the gift options algorithm 110 may be more likely to select these new one or more gift options created by the user for presentation to other users.

In some instances, the gift options algorithm 110 is dynamically updated and/or re-trained in real-time as different users interact with different product detail pages as a result of interaction with different contextual gift advertisements. The machine learning system 106 may continuously, and in real-time, obtain feedback from these different users as these different users interact with the different product detail pages and corresponding gift options provided by the gifting distribution system 102. As this feedback is obtained, the machine learning system 106 may dynamically, and in real-time, update and/or re-train the gift options algorithm 110. This continuous and real-time updating and re-training of the gift options algorithm 110 may facilitate improvements to the gift options algorithm 110 that may allow for more accurate generation and presentation of gift options for any gift advertisements presented and for corresponding contextual signals and information.

As noted above, selection of a gift advertisement may redirect the user to a standalone website or page through which the user may purchase and request delivery of a gift to a particular recipient. The standalone website or page may be provided by the gifting distribution system 102, which may not be tied to a retailer website or other product detail page associated with a retailer. The gifting distribution system 102 may obtain product information corresponding to the one or more products that may be selected as possible gifts from one or more retailer systems 114 as described above. Thus, the standalone website or page may include product information such as images of the products, sizing options, color options, customization options, MSRP, actual sales prices, shipping costs, estimated taxes, and the like. However, unlike the product detail page provided by a retailer, the standalone website or page may be devoid of any branding or other information corresponding to the retailer from which the products may be sourced. Further, through the standalone website or page, the user may interact directly with the gifting distribution system 102 rather than through a retailer. Through the standalone website or page, the gifting distribution system 102 may present one or more gift options for purchasing and delivery of the gift based on the contextual signals and contextual information associated with the gift advertisement selected to access the standalone website or page, the user device 116, and the one or more retailer systems 114 that may make available the one or more product options presented on the standalone website or page.

Through the product detail page or standalone website/page, the user may provide one or more gift selections from the products offered on the product detail page or standalone website/page and from the one or more gift options generated by the gift options algorithm 110. These one or more gift selections may be processed by a gift creation sub-system 112, which may be configured to process these one or more gift selections in order to provide payment for the selected gift and to deliver the gift to an intended recipient 124. For example, if the user has selected an option to digitally deliver the gift to the recipient 124, the gift creation sub-system 112 may prompt the user to provide an electronic address (e.g., e-mail address, etc.) for the recipient 124. Further, in some instances, based on the contextual signals and contextual information, the gift creation sub-system 112 may provide the user with an option to purchase the gift immediately but to digitally deliver the gift at a later time, such as on a recipient's birthday as indicated by the user or otherwise determined based on the contextual signals from the user device 116. The gift creation sub-system 112 may further transmit transaction information for purchase of the gift to one or more payment systems 122 for payment authorization and processing.

Once the transaction has been completed, the gift creation sub-system 112 may generate the gift according to the product and gift option selections made by the user. For instance, if the gift is to be physically delivered to the recipient 124, the gift creation sub-system 112 may coordinate with a retailer system 114 associated with the gift to ship and deliver the gift to the recipient 124. If the gift is to be gift-wrapped and/or include a customized card or note (e.g., Mother's Day card, birthday card, etc.), the gift creation sub-system 112 may coordinate with the retailer system 114 associated with the gift to ensure that the gift is wrapped and that the requested card or note is included with the gift according to the selected gift options. This may include having the retailer ship the gift to a third-party to perform these additional operations according to the selected gift options.

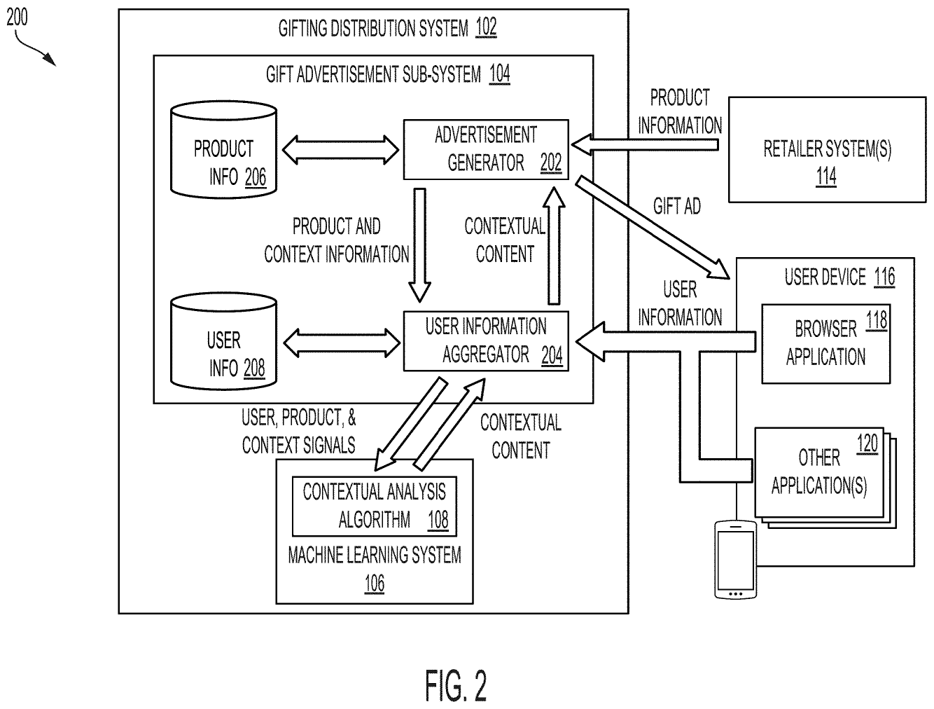

FIG. 2 shows an illustrative example of an environment 200 in which a gifting distribution system 102 generates one or more gift advertisements using product information from retailer systems 114 and contextual signals garnered from a user device 116 and the retailer systems 114 in accordance with at least one embodiment. In the environment 200, the gift advertisement sub- system 104 of the gifting distribution system 102 may include an advertisement generator 202 that is configured to automatically generate gift advertisements that may be presented to a user through a browser application 118 or other application 120 implemented on a user device 116. The advertisement generator 202 may be implemented as an application or other executable process on a computing system or other system (e.g., server, etc.) of the gifting distribution system 102. In an embodiment, the advertisement generator 202 can obtain product information from one or more retailer systems 114 and corresponding to one or more products that may be advertised as gifting ideas to users. In some instances, the advertisement generator 202 may store product information from these one or more retailer systems 114 in a product information repository 206, which the advertisement generator 202 may query to select product information that may be presented in a gift advertisement. For instance, as described in greater detail herein, the advertisement generator 202 may use contextual content from a user information aggregator 204 and obtained through the contextual analysis algorithm 108 to determine what product information may be included in a gift advertisement along with the contextual content. In some instances, the product information may be selected based on input from the one or more retailer systems 114. For example, the one or more retailer systems 114 may provide product information related to a particular inventory of products that may be offered as gift ideas to users. Accordingly, the resulting gift advertisement may include product information associated with one or more of these products.

In an embodiment, the advertisement generator 202 can obtain contextual information from the one or more retailer systems 114. For instance, the one or more retailer systems 114, through one or more APIs exposed by the advertisement generator 202, may push this contextual information to the advertisement generator 202. In some instances, the advertisement generator 202 may query or otherwise pull this contextual information from the one or more retailer systems 114. The contextual information may be obtained in real-time as the contextual information is generated by the one or more retailer systems 114. For instance, the advertisement generator 202 may maintain a data stream or feed through which any updates or new contextual information are automatically and in real-time provided to the advertisement generator 202. In some examples, the advertisement generator 202 may obtain the contextual information from the one or more retailer systems 114 periodically (e.g., every day, every week, seasonal, etc.) or in response to a triggering event (e.g., a retailer has initiated a sale, the date is within a pre-determined period of time from a known regional and/or national holiday or other event, etc.). This contextual information obtained from the one or more retailer systems 114 may include any sales/discount information related to products offered by the retailer systems 114, any relevant dates (e.g., dates corresponding to the beginning and end of sales, dates corresponding to regional and/or national holidays, etc.), amount of stock for the products offered by the retailer systems 114, and the like. The advertisement generator 202 may provide, in real-time, this product and contextual information from the retailer systems 114 (as the information is received) and the product information repository 206 to a user information aggregator 204, which may be configured to aggregate contextual information associated with a user with the product and contextual information from the retailer systems 114 and the product information repository 206.

The user information aggregator 204 may be implemented as an application or other executable process on a computing system or other system (e.g., server, etc.) of the gifting distribution system 102. In an embodiment, when a user accesses a website through a browser application 118, or otherwise utilizes any other application 120 through which advertisements may be presented, contextual signals associated with the user may be obtained by the user information aggregator 204. As noted above, the gift advertisement sub-system 104 can use a cookie to obtain data about the user that may be used to generate a gift advertisement that is tailored to the user. Through the cookie, the user information aggregator 204 may collect clickstream data, search data, purchase data, user profile data, and the like. This contemporaneous data may be aggregated with other user information from a user information datastore 208. The user information datastore 208 may include historical data corresponding to users to which gift advertisements are presented. For instance, over time, the user information aggregator 204 may collect data from the user device 116 (such as through the cookie, a browser extension, other applications 120, etc.) and store this data in the user information datastore 208. This data may allow the gift advertisement sub-system 104 to define a user profile for the particular user that may be used as contextual signals for determining how gift advertisements may be presented to the user.

It should be noted that while the illustrative example provided in FIG. 2 details the user information aggregator 204 performing the operations described herein for a single user device 116, the user information aggregator 204, in an embodiment, can perform aggregation of contextual signals, user information, and other user data for different users in real-time as these different users access one or more websites and/or applications implemented on their user devices through which gift advertisements may be presented. For example, if two or more users simultaneously access a webpage or application through which gift advertisements may be presented, the user information aggregator 204, in real-time, may aggregate the contextual signals, user information, and other user data for each of these users.

The user information aggregator 204 may provide the obtained user information, product information, and contextual signals from both the user device 116 and the advertisement generator 202 to the contextual analysis algorithm 108 implemented in a machine learning system 106. As noted above, the contextual analysis algorithm 108 may be dynamically trained to use the user information, product information, and contextual signals as input to determine the contextual content that is to be included in a gift advertisement that is to be presented to the user. Returning to the example described above in connection with FIG. 1, if the contextual signals and other information correspond to Mother's Day and an urgent need to purchase a gift for a recipient for Mother's Day, the contextual analysis algorithm 108 may output contextual content that is related to Mother's Day and that expresses to the user that they should not delay in purchasing a gift for Mother's Day (e.g., “Mother's Day is almost here! It's not too late to get her that gift she deserves!,” etc.). As another illustrative example, if the contextual signals and other information correspond to a recipient's upcoming birthday and the user has been researching various video games for the recipient, the contextual analysis algorithm 108 may output contextual content that is related to the recipient's birthday and that includes product information related to one or more video games that the recipient may be interested in based on the user's research (e.g., “Kelly Kirkpatrick's birthday is coming up! Get him that Switch® game you know he will love!,” product images of the one or more video games, etc.).

The user information aggregator 204, in response to obtaining the contextual content from the contextual analysis algorithm 108, may store the contextual content in the user information datastore 208. For instance, the user information aggregator 204 may associate the contextual content with an entry in the user information datastore 208 that corresponds to the user to which the contextual gift advertisement is to be presented. This may allow the user information aggregator 204 to collect data corresponding to the user's interactions with the contextual gift advertisement and, more specifically, the contextual content generated by the contextual analysis algorithm 108. The user information aggregator 204 may use this data to re-train and/or reinforce the contextual analysis algorithm 108, as described in greater detail herein.

In addition to storing the contextual content in the user information datastore 208, the user information aggregator 204 may transmit the contextual content to the advertisement generator 202. The advertisement generator 202 may automatically process the contextual content to determine what product information may be included in the gift advertisement to be presented to the user. For example, if the contextual content indicates a particular product that may be promoted as a possible gift idea, the advertisement generator 202 may query the product information repository 206 to obtain product information associated with the particular product (e.g., product name, product images, product pricing information, etc.). Further, the advertisement generator 202 may transmit a request to a retailer system 114 associated with the product to obtain any new or updated product information associated with the particular product. As noted above, in some instances, the retailer systems 114 may automatically push available product information to the advertisement generator 202 such that the advertisement generator 202 need not submit requests for new or updated product information. Similarly, as noted above, the advertisement generator 202 may automatically pull the available product information from the retailer systems 114 in real-time (such as through an active data stream or feed maintained between the advertisement generator 202 and the one or more retailer systems 114), periodically, or in response to a triggering event, as described above.

Using the contextual content obtained from the contextual analysis algorithm 108 and the available product information, the advertisement generator 202 may generate a gift advertisement that may be presented to the user via the browser application 118 and/or any other application 120 implemented on the user device 116. The gift advertisement may include various elements that allow a user to review the proposed gift idea and to select the contextual gift advertisement in order to access a product detail page or a standalone page associated with the gifting distribution system 102 in order to purchase and deliver a gift to an intended recipient. The gift advertisement may include an image, digital video, or other visual element associated with one or more products that may be available for purchase and delivery as a gift. Additionally, the gift advertisement may include the contextual content generated by the contextual analysis algorithm 108. For example, if the gift advertisement is being presented within a small window of time prior to Thanksgiving, the gift advertisement may include contextual information associated with Thanksgiving and convey a sense of urgency in purchasing a gift (e.g., “Thanksgiving is around the corner! Be sure to gobble up these savings for your special someone!”). The gift advertisement may further include one or more interaction elements that may be selected to access a product detail page or a standalone page associated with the gifting distribution system 102 in order to purchase and deliver a gift to an intended recipient. For example, the one or more interaction elements may include a GUI button that provides a signal to the user to select the button in order to purchase a gift for a recipient. The GUI button, for example, may include text such as “Gift Now!,” “Get Started!,” “Get Him a Gift!,” or other similar text that may be indicative of a gift creation process.

In an embodiment, user interactions with the gift advertisement may be recorded in real-time by the user information aggregator 204 as these user interactions occur for use in re-training and/or reinforcing the contextual analysis algorithm 108. For example, if the user dismisses the gift advertisement or otherwise indicates that the gift advertisement is not relevant to the user's needs, the user information aggregator 204 may use this feedback to re-train the contextual analysis algorithm 108 such that, for similar users and for similar product information and contextual signals, the likelihood of the contextual analysis algorithm 108 generating similar contextual content is reduced. In some instances, if the user dismisses the gift advertisement presented, the user information aggregator 204 may automatically prompt the user to provide feedback with regard to the gift advertisement. This feedback may be used to better determine why the gift advertisement was dismissed (e.g., the user did not find the advertisement to be relevant, the advertisement included erroneous contextual content, the products presented in the gift advertisement are not appealing or are unavailable for purchase, etc.). This feedback may also be used to dynamically re-train the contextual analysis algorithm 108 in order to produce more accurate contextual content for similar users and for similar products and contextual signals. Alternatively, if the user interacts with the gift advertisement and subsequently purchases a gift that is delivered to a recipient, the user information aggregator 204 may use this feedback to reinforce the contextual analysis algorithm 108 such that, for similar users and similar product information and contextual signals, the likelihood of the contextual analysis algorithm 108 in producing similar contextual content may be increased. In some instances, any feedback garnered from the user may be added to the sample dataset used to continuously, and iteratively, train the contextual analysis algorithm 108 over time.

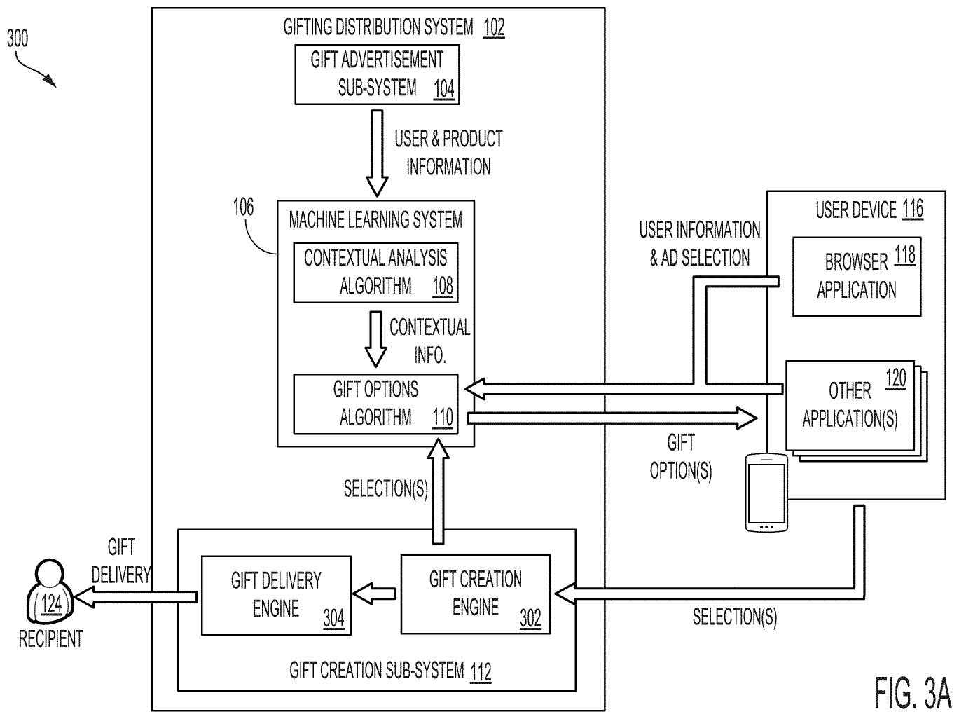

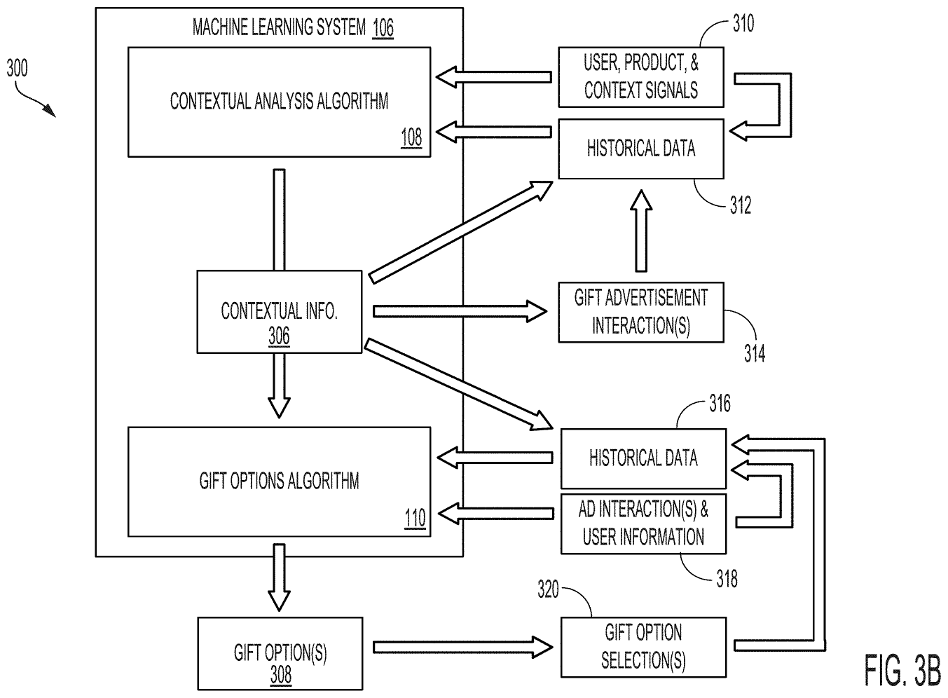

FIG. 3A shows an illustrative example of an environment 300 in which one or more options for generating a gift object are provided to a user device 116 based on contextual information corresponding to selection of an advertisement and to the user device 116 in accordance with at least one embodiment. In the environment 300, a user, through a browser application 118 or any other application 120 implemented on a user device 116, may select a gift advertisement presented to the user to request creation of a gift that may be delivered to a recipient 124. As noted above, the gift advertisement may include contextual information generated in response to one or more contextual signals from a retailer system and from the user device 116. For example, the gift advertisement may include contextual information related to an upcoming holiday as determined based on a date within an article being looked at by the user. As another illustrative example, the gift advertisement may include contextual information related to an event associated with the recipient 124 (e.g., “Kelly Kirkpatrick's birthday is coming up! Be sure to get him that gift he will love!,” etc.) as determined based on contextual signals from the user's calendar, electronic messages, social media comments/posts, and the like.

In an embodiment, if the user selects a gift advertisement presented to the user, the gift options algorithm 110 implemented on the machine learning system 106 can automatically and in real-time obtain additional user information from the user device 116, as well as previously obtained user and product information from the gift advertisement sub-system 104, to generate one or more gift options that may be presented to the user. The additional information garnered from the user device 116 may include user data that may be obtained after presentation of the gift advertisement. This user data may be obtained via one or more cookies (e.g., clickstream data, search data, purchase data, user profile data, etc.), data corresponding to content presented on a website or application, data obtained from e-mails or social media posts/comments, and the like. The new information garnered from the gift advertisement sub-system 104 (such as through a retailer system, etc.) may include messages transmitted by a retailer to users related to the products being offered for gifting, shipping cutoff dates, sale/discount cutoff dates, and the like. The gift options algorithm 110 may also analyze, in real-time and in addition to the additional information from the user device 116 and the retailer, the contextual information generated by the contextual analysis algorithm 108 and presented in the selected gift advertisement.

As noted above, the gift options algorithm 110 may be dynamically trained to generate or otherwise identify gift options that may be presented to a user through a product detail page or standalone page corresponding to the contextual gift advertisement based on the contextual information presented in the gift advertisement, any new contextual signals, and other new information from the user device 116 and the retailer system(s) providing the one or more products available for creation of a gift. For instance, if the contextual signals from the user device 116 are indicative of the user having a short amount of time to provide a gift to a recipient 124, the gift options algorithm 110 may automatically generate one or more gift options that correspond to expedited shipping of the gift and/or digital delivery of the gift. As another illustrative example, if the contextual signals and contextual information correspond to a recipient's upcoming birthday, the gift options algorithm 110 may generate one or more gift options that include an option for gift wrapping, an option for including a birthday card with the gift, options corresponding to shipping methods based on the proximity to the actual birthday, and the like. These gift options may be presented to the user via the product detail page or standalone page corresponding to the selected gift advertisement. Thus, through the product detail page or standalone page, the user may determine the parameters of the gift (e.g., the product, sizing or other customization details related to the product, any cards/notes to be provided with the product, method of delivery, timing of delivery, etc.).

Through the product detail page or standalone website/page, the user may provide one or more gift selections from the products offered on the product detail page or standalone website/page and from the one or more gift options generated by the gift options algorithm 110. These one or more gift selections may be processed by a gift creation engine 302 of the gift creation sub-system 112. The gift creation engine 302 may be implemented as an application or executable process of the gift creation sub-system 112. In an embodiment, the gift creation engine 302 is configured to process the one or more gift option selections made by the user in order to generate the gift according to these selections. For example, the gift creation engine 302 may coordinate with a retailer in order to obtain or otherwise reserve a particular product that is to serve as the gift that is to be delivered to the recipient 124. Further, the gift creation engine 302 may coordinate with one or more third-party entities in order to prepare the gift according to the selected options. These third-party entities may include gift wrapping service providers, greeting card service providers, and the like. For example, if the user has selected a gift option to include a customized card with the gift, the gift creation engine 302 may coordinate with a greeting card service provider to provision the customized card that is to be included with the gift. The gift creation engine 302 may further process payment for the selected gift. For instance, the gift creation engine 302 may transmit transaction information for purchase of the gift to one or more payment systems for payment authorization and processing.

In an embodiment, the gift creation engine 302 can prompt the user to provide delivery information for the recipient 124. For example, if the user has selected an option to digitally deliver the gift to the recipient 124, the gift creation engine 302 may prompt the user to provide an electronic address (e.g., e-mail address, etc.) for the recipient 124. Alternatively, if the user has selected an option to have the gift delivered to the recipient 124 at a physical address, the gift creation engine 302 may prompt the user to provide the physical address for the recipient 124.

In some instances, the gift creation engine 302 may provide, in real-time and as selections are made by the user, these selections made by the user to the gift options algorithm 110 to allow for re-training or reinforcement of the gift options algorithm 110. For example, if the user foregoes use of the provided one or more gift options and instead selects a gift using other options manually selected by the user through the product detail page or standalone website/page, the gift creation engine 302 may provide data corresponding to the user's selection of these other options over those provided by the gift options algorithm 110 to re-train the gift options algorithm 110. This may decrease the likelihood that the gift options algorithm 110 will provide the one or more previously provided gift options for similar users and/or similar gift advertisements. Further, this re-training of the gift options algorithm 110 may result in the gift options algorithm 110 providing gift options similar to those manually selected by the user for similar users and/or gift advertisements. Thus, as users select gift options for creating a gift for a recipient 124, the gift options algorithm 110 may be updated in real-time continuously, and iteratively, over time.

The gift creation engine 302 may provide the obtained delivery information, as well as any information regarding coordination among the retailer and any third-party entities for preparation of the gift, to a gift delivery engine 304 of the gift creation sub-system 112. The gift delivery engine 304 may be implemented as an application or executable process of the gift creation sub-system 112. In an embodiment, the gift delivery engine 304 is configured to deliver the gift to an intended recipient 124. For example, if the user has selected an option to digitally deliver the gift to the recipient 124, the gift delivery engine 304 may transmit an electronic message that includes one or more redemption options (e.g., electronic gift card, link to a web site associated with a retailer or the gifting distribution system 102, etc.) for the gift to an electronic address (e.g., e-mail address, etc.) associated with the recipient 124. If the gift is to be physically delivered to the recipient 124, the gift delivery engine 304 may coordinate with a retailer system associated with the gift to ship and deliver the gift to the recipient 124. If the gift is to be gift-wrapped and/or to include a customized card or note (e.g., Mother's Day card, birthday card, etc.), the gift delivery engine 304 may monitor the retailer system and any third-party entities (as indicated by the gift creation engine 302) to ensure that the gift is wrapped and that the requested card or note is included with the gift according to the selected gift options.

FIG. 3B shows an illustrative example of an environment 300 in which a machine learning system 106 implements and continuously updates machine learning algorithms 108, 110 used to generate contextual information 306 for the creation of gift advertisements and to generate the one or more gift options 308 for generating a gift object in accordance with at least one embodiment. In the environment 300, the machine learning system 106 implements a contextual analysis algorithm 108 to generate contextual information 306 that may be included in a gift advertisement that is to be presented to a user. As noted above, the contextual analysis algorithm 108 may obtain user information, production information, and contextual signals 310 (hereinafter referred to as “contextual input 310”) from a user information aggregator.

The contextual input 310 may be obtained in real-time and in response to user access at a website or other content accessed through a browser application or other application implemented on a user device. The contextual input 310 may be obtained in real-time as the user interacts with the website or other content accessed by the user. For example, as the user navigates through a website or other content (e.g., scrolls through an article, makes selections, clicks on objects, etc.), the contextual input 310 may be obtained and provided to the contextual analysis algorithm 108. In some instances, the contextual input 310 can include information scraped in real-time from the website or other content accessed by the user. For example, the user information aggregator (such as user information aggregator 204 described above in connection with FIG. 2) can dynamically scrape a presented article for one or more contextual signals that can be used to determine what contextual information and products may be presented to the user as gift ideas in a gift advertisement. As an illustrative example, the user information aggregator may scrape a presented article to identify the publication date of the article. Based on the publication date, the user information aggregator may determine whether this date is within days of a holiday or other event of relevance to the user for that year, which may serve as a contextual signal.

The contextual input 310 may further include data obtained through use of a cookie and/or browser extension implemented on a user device. Through the cookie and/or browser extension, clickstream data, search data, purchase data, user profile data, and the like may be collected and added to the contextual input 310 to be processed using the contextual analysis algorithm 108. This contemporaneous data may be aggregated with historical data 312 that corresponds to users to which gift advertisements are presented. For instance, over time, as data is collected from the user device (such as through the cookie, a browser extension, other applications, etc.), the historical data 312 may be dynamically updated and stored. This historical data 312 may allow for the creation of a user profile for the particular user that may be used as contextual signals for determining how gift advertisements may be presented to the user. The historical data 312 may further include historical information associated with other users, the contextual information generated and presented to these other users, and user interactions with gift advertisements presented to these other users over time.

The contextual analysis algorithm 108 may automatically and in real-time process the contextual input 310 to determine the contextual information 306 that is to be included in a gift advertisement that is to be presented to the user. Returning to the example described above in connection with FIG. 1, if the contextual input 310 is indicative of Mother's Day quickly approaching and further corresponds to an urgent need to purchase a gift for a recipient for Mother's Day, the contextual analysis algorithm 108 may output contextual information 306 that is related to Mother's Day and that expresses to the user that they should not delay in purchasing a gift for Mother's Day (e.g., “Mother's Day is almost here! It's not too late to get her that gift she deserves!,” etc.). As another illustrative example, if the contextual input 310 is indicative of a recipient's upcoming birthday and of the user having been researching various video games for the recipient, the contextual analysis algorithm 108 may output contextual information 306 that is related to the recipient's birthday and that includes product information related to one or more video games that the recipient may be interested in based on the user's research (e.g., “Kelly Kirkpatrick's birthday is coming up! Get him that Switch® game you know he will love!,” product images of the one or more video games, etc.).

As users interact with the gift advertisements presented, interactions 314 with these gift advertisements may be recorded and added to the historical data 312 in real-time for use in re-training and/or reinforcing the contextual analysis algorithm 108. For example, if a user dismisses a gift advertisement or otherwise indicates that a gift advertisement is not relevant to the user's needs, this feedback may be added to the historical data 312 to dynamically re-train the contextual analysis algorithm 108 such that, for similar users and for similar product information and contextual signals, the likelihood of the contextual analysis algorithm 108 generating similar contextual content is reduced. In some instances, if a user dismisses a gift advertisement presented, the user may be automatically prompted to provide feedback with regard to the gift advertisement. This feedback may be used to better determine why the gift advertisement was dismissed. This feedback may also be added to the historical data 312 and used to re-train the contextual analysis algorithm 108 in order to product more accurate contextual content for similar users and for similar products and contextual signals. Alternatively, if a user interacts with a gift advertisement and subsequently purchases a gift that is delivered to a recipient, this feedback may be added to the historical data 312 and used to reinforce the contextual analysis algorithm 108 such that, for similar users and similar product information and contextual signals, the likelihood of the contextual analysis algorithm 108 in producing similar contextual content may be increased. In some instances, any feedback garnered from different users may be added to a sample dataset in the historical data 312 used to continuously, iteratively, and in real-time train the contextual analysis algorithm 108 over time.

As noted above, the machine learning system 106 further includes a gift options algorithm 110 that is dynamically trained to generate or otherwise identify gift options that may be presented to a user through a product detail page or standalone page corresponding to a gift advertisement presented to the user. The gift options algorithm 110 may obtain, in real-time, data corresponding to user selection of a presented gift advertisement and user information associated with the user that has selected the presented gift advertisement (hereinafter referred to as “selection input 318”). The selection input 318 may include user data that may be obtained after presentation of the gift advertisement. This user data may include data obtained via cookies and/or browser extensions (e.g., clickstream data, search data, purchase data, user profile data, etc.), data corresponding to content presented on a website or application, data obtained from e-mails or social media posts/comments, and the like. The selection input 318 may further include messages transmitted by a retailer to users related to the products being offered for gifting, shipping cutoff dates, sale/discount cutoff dates, and the like. The gift options algorithm 110 may also obtain, in addition to the selection input 318, the contextual information 306 generated by the contextual analysis algorithm 108 and presented in the selected gift advertisement.

The selection input 318 and the contextual information 306 may be aggregated with historical data 316 that corresponds to gift options presented to other users based on gift advertisements presented to these other users and to user selections amongst these presented gift options. For instance, over time, as data is collected corresponding to gift options presented to users and their selections, the historical data 316 may be dynamically updated and stored. Further, the historical data 316 may indicate user interactions with presented gift options, including user interactions whereby users may forego selection of presented gift options in favor of manual selection of a gift. Thus, the historical data 316 may indicate various associations between previously presented gift advertisements, corresponding contextual information, presented gift options, and user selections over time.

The gift options algorithm 110 may process the selection input 318, as well as the historical data 316 and the contextual information 306 in real-time to generate one or more gift options 308 that may be dynamically presented to the user through a product detail page or standalone page associated with the selected gift advertisement. For instance, if the contextual signals from a user device are indicative of a user having a short amount of time to provide a gift to a recipient, the gift options algorithm 110 may dynamically generate one or more gift options that correspond to expedited shipping of the gift and/or digital delivery of the gift. As another illustrative example, if the contextual signals and contextual information 306 correspond to a recipient's upcoming birthday, the gift options algorithm 110 may dynamically generate one or more gift options that include an option for gift wrapping, an option for including a birthday card with the gift, options corresponding to shipping methods based on the proximity to the actual birthday, and the like. These gift options may be dynamically presented to the user via the product detail page or standalone page corresponding to the selected gift advertisement.

As a user interacts with the presented gift options 308, any gift option selections 320 made by the user may be recorded in real-time and added to the historical data 316. For example, if a user foregoes use of the provided one or more gift options and instead selects a gift using other options manually selected by the user through the product detail page or standalone website/page, the data corresponding to the user's selection of these other options over those provided by the gift options algorithm 110 may be added to the historical data 316 in order to re-train the gift options algorithm 110. This may decrease the likelihood that the gift options algorithm 110 will provide the one or more previously provided gift options for similar users and/or similar gift advertisements. Further, this re-training of the gift options algorithm 110 may result in the gift options algorithm 110 providing gift options similar to those manually selected by the user for similar users and/or gift advertisements. Thus, as users select gift options for creating a gift for a recipient, the historical data 316 used to train the gift options algorithm 110 may be updated continuously, and iteratively, over time. This may allow for continual re-training and reinforcement of the gift options algorithm 110 in real-time as users make selections from the gift options presented to these users and generated by the gift options algorithm 110.

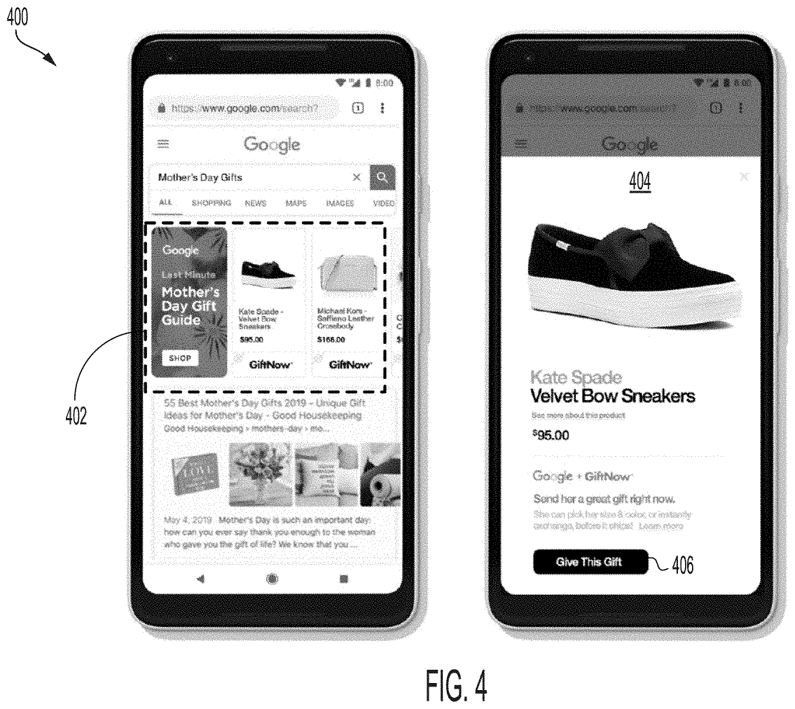

FIG. 4 shows an illustrative example of an environment 400 in which contextual information garnered from search terms submitted by a user and from product details obtained from one or more retailers is used to generate one or more advertisements 402 that are presented in accordance with at least one embodiment. In the environment 400, a user has used a browser application implemented on its user device to submit a search query to an online search engine. For example, as illustrated in FIG. 4, the user has submitted the search terms “Mother's Day Gifts,” which may indicate that the user is interested in identifying possible Mother's Day gifts for a possible recipient. In response to this query, the search engine may return one or more results corresponding to websites or pages that are relevant to the query. For instance, the first result may correspond to the best Mother's Day gifts as determined by an online publication.

In an embodiment, the gifting distribution system can use the search terms submitted to the search engine as a contextual signal that may be used to generate one or more gift advertisements 402 that may be presented to the user along with the one or more results provided by the search engine. For example, the gifting distribution system can obtain the search terms submitted by the user from the search engine and process these search terms using the machine learning system described above to obtain contextual information that may be presented to the user in a gift advertisement 402. In some instances, the gifting distribution system may use a cookie to collect data corresponding to the user's online interactions with the search engine and other websites through the browser application. As noted above, through the cookie, the gifting distribution system may collect clickstream data, search data (e.g., “Mother's Day Gifts,” etc.), purchase data, user profile data, and the like. In some instances, the gifting distribution system may obtain the search terms submitted by the user through a browser extension or other executable process that may be executed when the browser application is executed. Thus, as the user submits the search terms, the browser extension may obtain and provide these search terms to the gifting distribution system.

In addition to obtaining the search terms submitted by the user, the gifting distribution system may obtain other contextual signals from the user, the search engine, one or more retailers, and any other entities in order to determine what contextual information may be included in the one or more gift advertisements 402. For example, in addition to the search terms “Mother's Day Gifts,” the gifting distribution system may determine the current date and its relation to Mother's Day. This may allow the gifting distribution system to determine the window of time available for purchasing and delivery of a gift to a recipient ahead of Mother's Day. This may further correlate to a level of urgency for the user. For instance, if the search query is submitted within a week of Mother's Day, the gifting distribution system may determine that the user is urgently trying to identify a gift that needs to be delivered to a recipient prior to Mother's Day.

Additionally, the gifting distribution system may obtain, from one or more retailer systems, product information that may be used to determine what products may be presented in the one or more gift advertisements 402 as possible gift ideas. The product information may include images of products, any sales or discounts applied to the products, the MSRP of the products, availability or stock information associated with the products, shipping information associated with the products, and the like. The gifting distribution system may use this product information, as well as any contextual signals related to the user to identify one or more products that may be presented in the gift advertisements 402. For example, the gifting distribution system may use purchase data associated with the user and corresponding to previous purchases made for Mother's Day to identify possible gift ideas that may be presented to the user. As another example, the gifting distribution system may use comments or posts previously submitted by the user via social media and related to Mother's Day to identify possible gift ideas that may be presented to the user.

As noted above, the one or more gift advertisements 402 may include contextual information related to the search terms submitted by the user and to the level of urgency detected for purchasing a gift for a recipient. For example, as illustrated in FIG. 4, the one or more gift advertisements 402 may indicate that the gift ideas presented are related to Mother's Day (e.g., “Mother's Day Gift Guide”). Further, based on the level of urgency detected, the one or more gift advertisements 402 may provide an indication acknowledging this level of urgency (e.g., “Last Minute”).

The one or more gift advertisements 402 may further provide one or more gift ideas, along with product information associated with these gift ideas, to the user. For example, as illustrated in FIG. 4, the one or more gift ideas may include product images corresponding to these one or more gift ideas and pricing information corresponding to these one or more gift ideas. In some instances, the gifting distribution system may provide a GUI button or other interface element that allows the user to select a particular gift idea. For example, as illustrated in FIG. 4, each gift idea presented in the one or more gift advertisements 402 may include a “GiftNow” GUI button that, if selected, may redirect the user to a standalone website or page 404 provided by the gifting distribution system and corresponding to the gift idea selected. It should be noted that while the GUI button illustrated in FIG. 4 may redirect the user to a standalone website or page 404 provided by the gifting distribution system, the GUI button may be configured to redirect a user to a retailer website or page provided by the retailer through which the gift idea may be purchased directly.

Through the standalone website/page 404, the gifting distribution system may provide additional product information associated with the selected gift idea or otherwise more prominently display the product information associated with the selected gift idea. For example, through the standalone website/page 404, the gifting distribution system may provide a larger image of the product, provide a link that may redirect the user to a website or page through which the user may obtain additional product information associated with the selected gift idea, pricing information associated with the gift idea, and the like. In an embodiment, because the standalone website/page 404 is provided by the gifting distribution system, the standalone website/page 404 can be presented without being tied to a retailer's website or page.

The standalone website/page 404 may further include a generate gift button 406 (e.g., “Give This Gift”) or other interface element through which the user may request delivery of the particular gift idea being presented on the standalone website/page 404. If the user selects the generate gift button 406, the gifting distribution system may prompt the user to select a delivery option for delivery of the gift to the recipient. For example, if the user selects an option to digitally deliver the gift to the recipient, the gifting distribution system may prompt the user to provide an electronic address (e.g., e-mail address, etc.) for the recipient. Alternatively, if the user has selected an option to have the gift delivered to the recipient at a physical address, the gifting distribution system may prompt the user to provide the physical address for the recipient. In some instances, the delivery options may be tailored according to the contextual signals related to the user and the retailer from which the gift may be purchased. For example, if the user accesses the standalone website/page 404 in response to a last minute message provided by the retailer to users after a shipping cutoff, the gifting distribution system may focus the delivery options on digital delivery as the primary delivery or fulfillment option. As another example, if the user has indicated (e.g., via comments, posts, electronic messages, etc.) that they have a short time window to obtain and deliver a gift to the recipient, the gifting distribution system may focus the delivery options on expedited and digital shipping options. Additionally, once the user has selected any pertinent delivery and gift options (e.g., gift wrapping, additional card/note for the recipient, etc.), the gifting distribution system may prompt the user for payment of the gift.

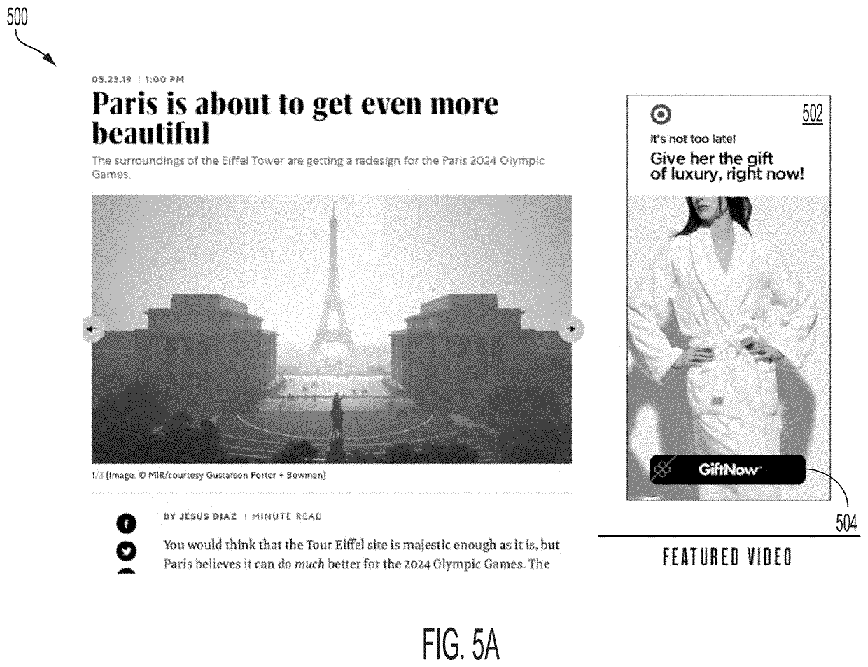

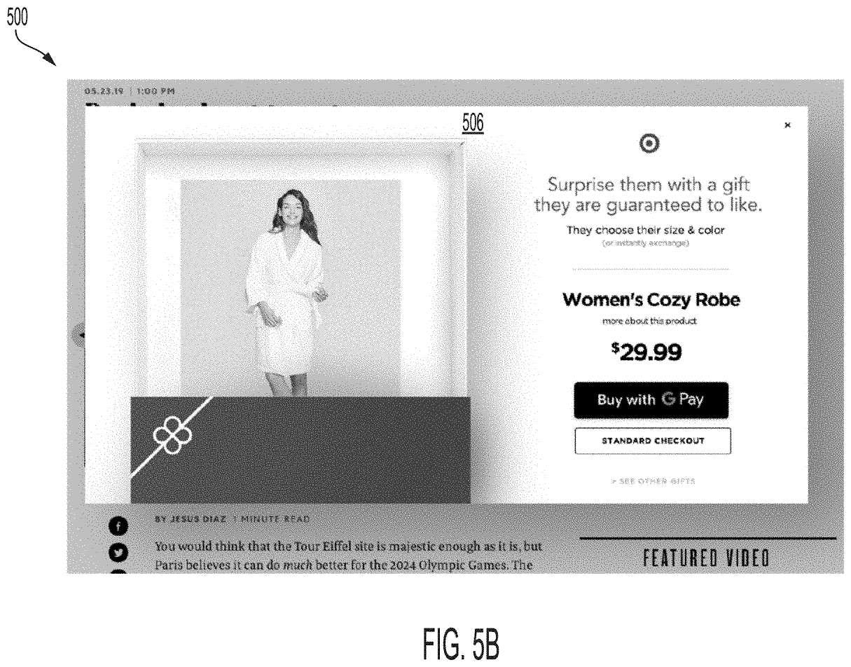

FIGS. 5A and 5B show an illustrative example of an environment 500 in which contextual information from an article and from product details obtained from one or more retailers is used to generate an advertisement 502 for generation of a gift object such that selection of the advertisement 502 results in presentation of a product detail page 506 for generation of the gift object in accordance with at least one embodiment. In the environment 500, a user has used a browser application implemented on their user device to access an article provided by an online publisher, such as a news agency or other entity. For example, as illustrated in FIG. 5A, the user has accessed an article about a redesign of the surroundings of the Eiffel Tower ahead of the 2024 Olympic Games. The article may include a publication date (e.g., May 23, 2019 at 1:00 P.M.) that may correspond to the date at which the article was published to the website or to the date at which the article was accessed by the user.

In an embodiment, the gifting distribution system can scrape the presented article for one or more contextual signals that can be used to determine what contextual information and products may be presented to the user as gift ideas in a gift advertisement 502. For example, the gifting distribution system may automatically and in real-time scrape the article as the article is presented to the user to identify the publication date of the article. As noted above, the date presented in the article illustrated in FIG. 5A is May 23, 2019 at 1:00 P.M. This date is within days of Mother's Day for that year, which may serve as a contextual signal. This contextual signal, as well as other contextual signals associated with the user and one or more retailers, may be processed by the gifting distribution system in real-time using a contextual analysis algorithm (e.g., a machine learning algorithm) to determine the contextual information that may be presented in a gift advertisement 502, as well as the product information that may be presented for a product that may be presented as a possible gift idea.

As illustrated in FIG. 5A, the gift advertisement 502 generated by the gifting distribution system may include an image of a product that may serve as a gift idea that may be purchased and delivered to a particular recipient. Additionally, the gift advertisement 502 may include contextual information related to the contextual signals detected from the presented article and from the user. Further, the contextual information may correspond to the level of urgency detected for purchasing a gift for a recipient. For example, as illustrated in FIG. 5A, the gift advertisement 502 may indicate that the gift idea presented corresponds to a product that may be given to a female recipient (e.g., “Give her the gift of luxury, right now!”). Further, based on the level of urgency corresponding to the proximity to Mother's Day, the gift advertisement 502 may provide an indication acknowledging this level of urgency (e.g., “It's not too late!”).

The gift advertisement 502 may further include a GUI button 504 or other interface element that allows the user to select the presented gift idea. For example, as illustrated in FIG. 5A, the gift idea presented in the advertisements 502 may include a “GiftNow” GUI button that, if selected, may cause the gifting distribution system to present an interstitial website or page 506 (as illustrated in FIG. 5B) provided by the gifting distribution system and corresponding to the gift idea selected. It should be noted that while the GUI button 504 illustrated in FIG. 5A may cause the gifting distribution system to present an interstitial website/page 506, the GUI button may be configured to redirect a user to a retailer website or page provided by the retailer through which the gift idea may be purchased directly. In some instances, the interstitial website or page 506 may be provided by a retailer associated with the product presented as a gift idea. Thus, in some instances, selection of the GUI button 504 may redirect the user to a product detail page provided by the retailer and augmented with one or more gift options provided by the gifting distribution system, as described herein. This product detail page may be provided via an interstitial overlayed over the article presented in FIG. 5A. Further, it should be noted that while the GUI button 504 is used extensively throughout the present disclosure for the purpose of illustration, other interface elements may be used to cause the gifting distribution system to present an interstitial website or page 506 (as illustrated in FIG. 5B) provided by the gifting distribution system and corresponding to the gift idea selected. For example, the gift advertisement 502 may be provided without a GUI button 504, whereby the user may select any portion of the gift advertisement 502 itself to cause the gifting distribution system to present the interstitial website or page. As another illustrative example, instead of the GUI button 504, the gift advertisement 502 may include a hyperlink, a GUI slider, or other interactable elements that may be interacted with to denote selection of the gift advertisement 502.

As illustrated in FIG. 5B, through the interstitial website/page 506, the gifting distribution system may provide additional product information associated with the selected gift idea or otherwise more prominently display the product information associated with the selected gift idea. For example, through the interstitial website/page 506, the gifting distribution system may provide additional and/or alternative images of the product, provide a link that may redirect the user to a website or page through which the user may obtain additional product information associated with the selected gift idea, pricing information associated with the gift idea, and the like. If the interstitial website/page 506 is provided by the gifting distribution system, the interstitial website/page 506 can be presented without being tied to a retailer's website or page. However, if the interstitial website/page 506 is provided by a retailer associated with the gift idea, the interstitial website/page 506 may be tied to the retailer's website or page. In this example, the interstitial website/page 506 may include identifying information of the retailer (e.g., logos, trademarks, etc.) that the user may use to readily identify the retailer from which the gift is being purchased for delivery to a recipient.

In an embodiment, the gifting distribution system can allow the user to purchase a gift without having to select one or more customization options (e.g., sizing, color, etc.) for the gift. For example, through the interstitial website/page 506, the gifting distribution system may indicate that the recipient may select the size and color of the product being delivered as a gift. Alternatively, if the user selects one or more customization options for the gift, the gift distribution system may indicate that the recipient may be permitted to instantly exchange the gift for a different product should the recipient not approve of the gift and/or the selected customization options. Thus, the gifting distribution system, through the interstitial website/page 506, may inform the user that the recipient may be notified with regard to a gift that is to be delivered to the recipient and that the recipient may be prompted to select one or more customization options for the gift (e.g., size and color, etc.), accept the options selected by the user, or exchange the gift for a different product.

The gifting distribution system may further provide the user with an option to purchase the gift using a third-party payment service (e.g., Google Pay™, etc.) or through a standard checkout process. Once the user has selected a payment option presented in the interstitial website/page 506, the gifting distribution system may prompt the user to select a delivery option for delivery of the gift to the recipient. For example, if the user selects an option to digitally deliver the gift to the recipient, the gifting distribution system may prompt the user to provide an electronic address (e.g., e-mail address, etc.) for the recipient. Alternatively, if the user has selected an option to have the gift delivered to the recipient at a physical address, the gifting distribution system may prompt the user to provide the physical address for the recipient. As noted above, the delivery options may be tailored according to the contextual signals related to the user and the retailer from which the gift may be purchased. Additionally, the gifting distribution system may prompt the user for payment of the gift.

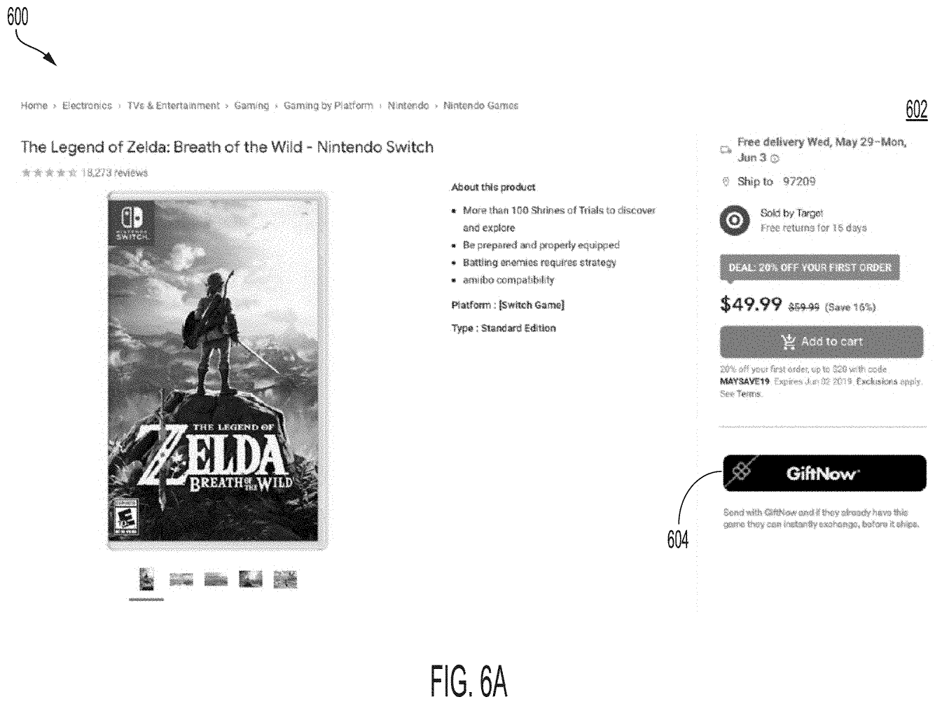

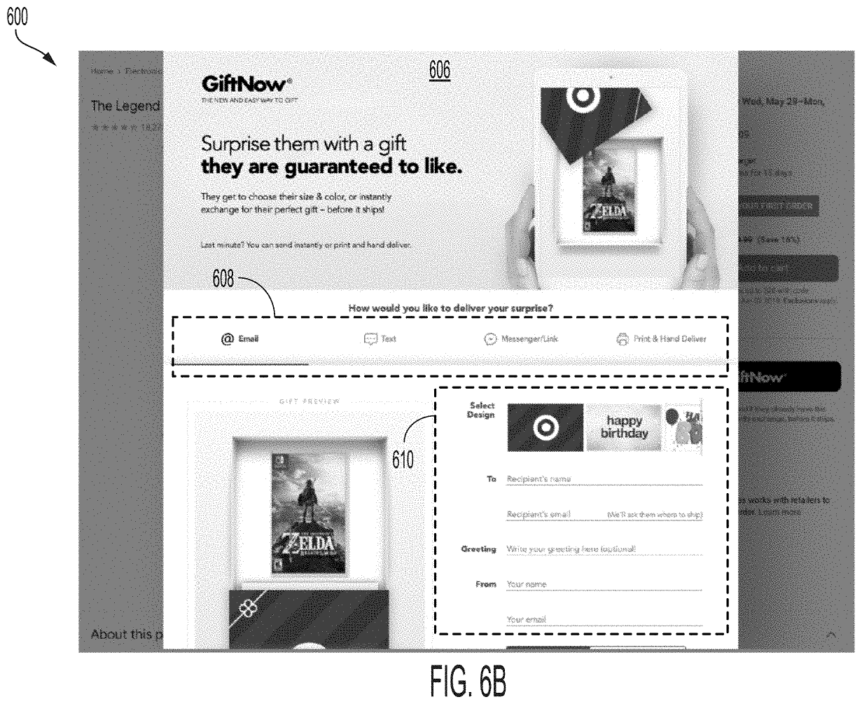

FIGS. 6A and 6B show an illustrative example of an environment 600 in which generation of a gift object is performed upon selection of an option 604 to generate the gift object presented through a retailer website 602 (also referred to herein as a product detail page 602) in accordance with at least one embodiment. In the environment 600, a user has used a browser application implemented on their user device to access a product detail page associated with a particular video game that may be available for purchase from a particular retailer. The product detail page may include detailed product information associated with the particular product presented. For example, as illustrated in FIG. 6A, the product detail page 602 includes one or more images of a particular product, detailed information about the product, one or more delivery options and other delivery information (e.g., estimated delivery dates, etc.) for the product, retailer information, MSRP of the product, sales or discount pricing (if available), an option to add the product to a virtual cart, and the like.

In an embodiment, the gifting distribution system can augment a product detail page 602 provided by a retailer in order to provide an option to generate a gift using the particular product being presented in the product detail page 602. For example, as illustrated in FIG. 6A, the gifting distribution system may augment the product detail page 602 to present a GUI button 604 or other interface element that may be selected to indicate that the user would like to purchase and deliver the product described in the product detail page 602 as a gift for a particular recipient. For example, as illustrated in FIG. 6A, the product detail page 602 may include a “GiftNow” GUI button that, if selected, may cause the gifting distribution system to present an interstitial website or page 606 (as illustrated in FIG. 6B) provided by the gifting distribution system and corresponding to the product being presented in the product detail page 602. In some instances, the interstitial website or page 606 may be provided by the retailer associated with the product presented in the product detail page 602.

In an embodiment, if the user selects the GUI button 604, the gifting distribution system can process contextual signals associated with the user and the retailer to determine contextual information that may be presented on the interstitial website or page 606. For example, the gifting distribution system may obtain the search terms submitted by the user to reach the product detail page 602 (e.g., “video games,” “switch games,” “Zelda,” etc.) and process these search terms using the machine learning system described above to obtain contextual information that may be presented to the user in the interstitial website/page 606. In some instances, the gifting distribution system may use a cookie to collect data corresponding to the user's online interactions with the retailer and other websites through the browser application. As noted above, through the cookie, the gifting distribution system may collect clickstream data, search data, purchase data, user profile data, and the like. In some instances, the gifting distribution system may obtain the search terms submitted by the user through a browser extension or other executable process that may be executed when the browser application is executed. The gifting distribution system can further scrape the product detail page 602 for one or more contextual signals that can be used to determine what contextual information and gift options may be presented to the user through the interstitial website/page 606. For example, the gifting distribution system may scrape the product detail page 602 to identify the shipping options and sales/discount duration for the product being offered. This information may be used as contextual signals that may be used to determine what delivery options may be available to the user for ensuring the gift is delivered to the recipient within a period of time, as determined based on contextual signals related to the user and/or recipient (e.g., an upcoming birthday, an upcoming holiday, etc.).

As illustrated in FIG. 6B, the delivery options 608 presented to the user within the interstitial website/page 606 may correspond to digital delivery of the gift. For example, the delivery options 608 may include delivery via electronic mail, text message, an instant messenger message or link, or hand delivery by the user. These delivery options 608 may be selected based on the contextual signals processed by the gifting distribution system. For instance, if the amount of time remaining before the recipient's birthday is short, whereby physical shipping of the gift would result in the gift arriving after the recipient's birthday, the gifting distribution system may determine, based on these contextual signals, that only digital delivery of the gift is available.

In addition to providing one or more delivery options 608, the gifting distribution system may provide one or more gift options 610 corresponding to add-ons for the gift that may be provided with the gift. For example, as illustrated in FIG. 6B, the gift distribution system may provide the user with an option to select a design for a card or note that may be included with the gift. Additionally, the gift options 610 may allow the user to provide the recipient's name, the recipient's contact information (according to the selected delivery option 608 and/or any other form of contact information), a greeting (e.g., “Happy Birthday!,” “Congratulations!,” etc.), and the sender's name and contact information. In some examples, the gift options 610 may allow the user to select a card or note that may be included with the gift, as well as the design of the card or note. The designs presented to the user as possible gift options 610 may correspond to the contextual signals obtained from the user. For example, as illustrated in FIG. 6B, the presented designs may correspond to the recipient's upcoming birthday, as determined based on the contextual signals detected by the gifting distribution system through evaluation of data associated with the user.

Once the user has selected the delivery and other gift options for the gift that is to be provided to the recipient, the user may proceed to provide payment information for processing of the transaction with the retailer. Thus, through selection of the GUI button to indicate that the user would like to purchase and deliver the product described in the product detail page 602 as a gift for a particular recipient, the gifting distribution system may surface, through the interstitial website/page 606, various gift options to the user prior to requiring payment.

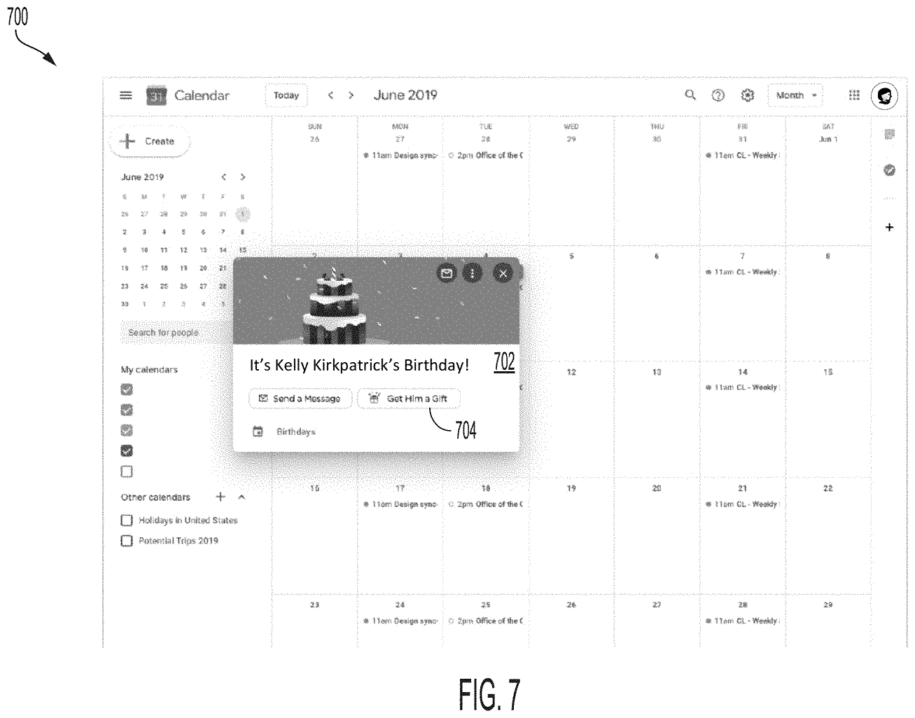

FIG. 7 shows an illustrative example of an environment 700 in which contextual information from a calendar associated with a user is processed to present the user with an option 704 to generate a gift object for a particular recipient in accordance with at least one embodiment. In the environment 700, a user has used a browser application implemented on their user device to access an online calendar or online planner through which the user may record any upcoming appointments, events, holidays, or any other dates that may be of significance to the user. For example, through the online calendar or online planner, the user may record a friend's birthday, which may serve as a reminder of this friend's birthday and to obtain a gift for that friend. It should be noted that the calendar or planner may be provided via another application implemented on the user device. This other application may be connected to one or more communications networks, such as the Internet. Further, this other application may be integrated with the gifting distribution system through the one or more communications networks. This may allow the gifting distribution system to obtain any contextual signals from the calendar or planner provided through the application.

In an embodiment, the gifting distribution system can scrape the user's calendar or planner to obtain one or more contextual signals that can be processed in order to determine whether to surface an option to generate a gift for a particular recipient. For instance, the user may execute a browser extension associated with the gifting distribution system and that is configured to scrape data from a presented website or page in order to detect any contextual signals that may be used to determine whether to surface an option to generate a gift for a particular recipient. The data scraped from the calendar or planner may be processed using a contextual analysis algorithm (e.g., machine learning algorithm) as described above. The output of the contextual analysis algorithm may include an indication as to whether the gifting distribution system is to surface an option to generate a gift to the user.

As illustrated in FIG. 7, the online calendar or planner may present the user with a reminder 702 corresponding to a friend's birthday (e.g., “It's Kelly Kirkpatrick's Birthday!”). Through the reminder 702, the online calendar or planner may provide the user with an option to transmit a message to this friend to wish him a happy birthday or to express any other appropriate sentiment to the friend. In an embodiment, the gifting distribution system automatically detects the reminder 702 as a contextual signal corresponding to the friend's birthday. Further, this contextual signal may indicate a high level of urgency as the reminder 702 was surfaced on the date of the friend's birthday, thereby limiting the amount of time for the user to purchase and deliver a gift to the friend. This may cause the gifting distribution system to generate one or more gift options that correspond to expedited shipping of the gift and/or digital delivery of the gift. Further, the one or more gift options may include an option for including a birthday card or note with the gift.

Through the reminder 702, the gifting distribution system may surface a GUI button 704 or other interface element that may be used by the user to request creation of a gift for a recipient (e.g., the friend indicated in the reminder 702). For example, as illustrated in FIG. 7, the reminder 702 may include a “Get Him a Gift” GUI button that, if selected, may redirect the user to a standalone website or page provided by the gifting distribution system through which the user may be presented with one or more gift ideas, delivery options, and gift options corresponding to add-ons or other instructions for delivery of the gift. It should be noted that while the GUI button 704 illustrated in FIG. 7 may redirect the user to a standalone website or page provided by the gifting distribution system, the GUI button 704 may be configured to redirect a user to a retailer website or page provided by a retailer through which different gift ideas may be presented and through which a gift may be purchased directly.

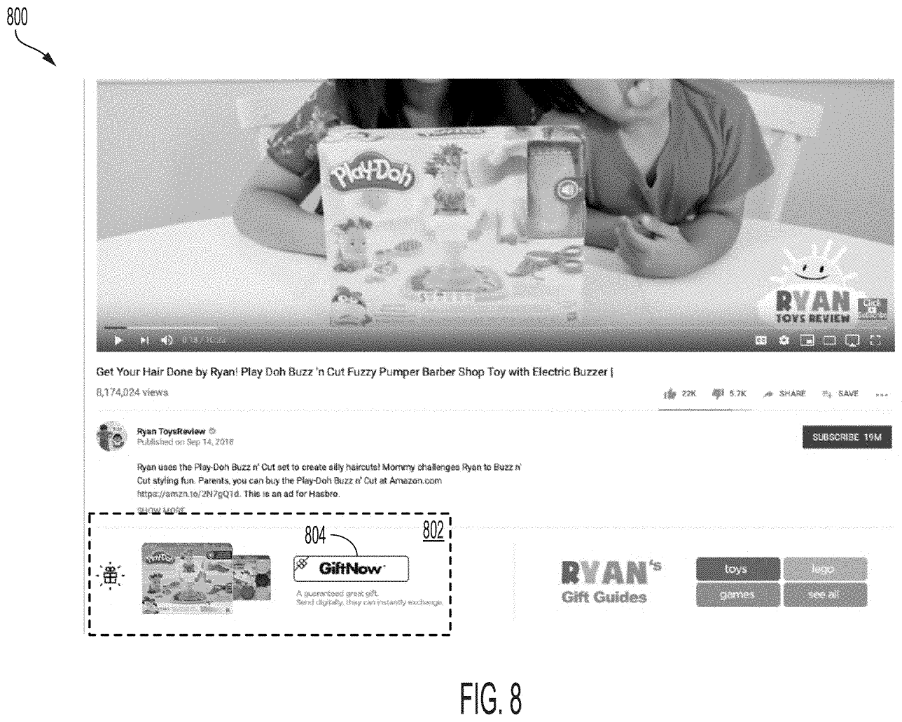

FIG. 8 shows an illustrative example of an environment 800 in which contextual information associated with content presented in a video or other digital media is used to generate and present an option 804 to generate a gift object in accordance with at least one embodiment. In the environment 800, a user has used a browser application implemented on their user device to access a video or other multimedia sharing website in order to watch a particular video. In some instances, the user may use an application associated with the video or other multimedia sharing website in order to watch the particular video or other multimedia content. As illustrated in FIG. 8, the user has accessed a video associated with a particular product that is being demonstrated by one or more reviewers or other content creators (e.g., children playing with a toy set, etc.). The video may present the one or more reviewers or other content creators interacting with the product being presented and providing their opinion with regard to the product. In some instances, a video may be presented whereby a product is not a central feature of the video but rather utilized in a secondary manner or otherwise used as a prop.

In an embodiment, the gifting distribution system can use computer vision or other machine learning algorithms/artificial intelligence to process the video or other multimedia being presented via the website or application to obtain contextual signals that may be used to identify contextual information that may be used to generate a gift advertisement 802. For example, the gifting distribution system may process the video using computer vision to identify the product being presented in the video. Further, from the video, the gifting distribution system may identify any product information associated with the product. For example, if during the video a reviewer, content creator, or other entity provides a detailed description of the product, including any price information, retailer information, customization information (e.g., color options, sizing options, etc.), and the like, the gifting distribution system may obtain this detailed description of the product through processing of the video using computer vision or other machine learning algorithm/artificial intelligence.

In some instances, the gifting distribution system may further scrape any textual information provided in conjunction with the video or other multimedia being presented via the website or application to obtain additional contextual signals that may be used to identify contextual information usable to generate the gift advertisement 802. For example, as illustrated in FIG. 8, the website through which the video is being presented may include a descriptive title for the video (e.g., “Get Your Hair Done by Ryan! Play Doh Buzz 'n Cut Fuzzy Pumper Barber Shop Toy with Electric Buzzer”), as well as a short description related to the video (e.g., “Ryan uses the Play-Doh Buzz 'n Cut set to create silly haircuts!,” etc.). As illustrated in FIG. 8, the short description related to the video may further include a hyperlink to a retailer through which the product being presented may be purchased. The gifting distribution system, using the aforementioned machine learning algorithms/artificial intelligence, may access the retailer to obtain any additional product information and other contextual signals (e.g., images of the product, any sales or discounts applied to the product, the MSRP of the product, availability or stock information associated with the product, shipping information associated with the product, and the etc.).

In some instances, if the gifting distribution system identifies, from the video or other multimedia content, a particular product that may be offered as a gift idea to the user, the gifting distribution system may query one or more retailer systems to obtain additional product information associated with the product. For example, if the video being presented includes a particular product but the video does not delve into various elements or features of the product, the gifting distribution system may query the one or more retailer systems to obtain any available product information associated with the particular product. This product information, as noted above, may include images of the product, pricing details of the product (e.g., sales prices, discounts, MSRP, etc.), sizing or color options for the product, and the like. As noted above, if the video is being presented with a textual description of the video content, the gifting distribution system may scrape this textual description to obtain additional product information associated with the product (if available). This may include identifying any hyperlinks or other content that may correspond to a particular retailer through which the product may be purchased or otherwise obtained.

In an embodiment, in addition to using computer vision to process the video or other multimedia content in order to detect a product that may be served as a gift idea, the gifting distribution system may obtain contextual signals associated with the user and with retailer(s) that offer the identified product for sale. As noted above, the gifting distribution system can use a cookie to obtain data about the user that may be used to generate a gift advertisement that is tailored to the user. Through the cookie, the gifting distribution system may collect clickstream data, search data, purchase data, user profile data, and the like. Additionally, the gifting distribution system may obtain contextual signals from a retailer that offers the identified product for sale. These contextual signals may include any sales/discount information related to the product offered by the retailer, any relevant dates (e.g., dates corresponding to the beginning and end of sales, dates corresponding to regional and/or national holidays, etc.), amount of stock for the product offered by the retailer, and the like. The user and retailer contextual signals, as well as the contextual signals obtained from the video or other multimedia content, may be processed using the aforementioned contextual analysis algorithm to identify the contextual information that may be presented in a gift advertisement 802 that is to be shown to the user via the website or application utilized to access the video or other multimedia content.

The gift advertisement 802 generated by the gifting distribution system may include an image of a product that may serve as a gift idea that may be purchased and delivered to a particular recipient. Additionally, the gift advertisement 802 may include contextual information related to the contextual signals detected from the presented video/multimedia content, from the retailer that offers the product for sale, and from the user. The contextual information may correspond to the level of urgency detected for purchasing a gift for a recipient. For example, if the gifting distribution system determines based on dialogue or other discussion presented in the video that the product is available for a limited time or that there is very limited stock available, the gift advertisement 802 may include contextual information that indicates that the user should act promptly to secure the product as a gift (e.g., “Don't wait! Get your friend that gift he deserves!,” etc.).

Similar to the other gift advertisements described above, the gift advertisement 802 may further include a GUI button 804 or other interface element that allows the user to select the presented gift idea. For example, as illustrated in FIG. 8, the gift idea presented in the gift advertisement 802 may include a “GiftNow” GUI button that, if selected, may cause the gifting distribution system to present an interstitial website or page provided by the gifting distribution system and corresponding to the gift idea selected. Alternatively, the “GiftNow” GUI button, if selected, may cause the gifting distribution system to redirect the user to a retailer website or page provided by the retailer through which the gift idea may be purchased directly.

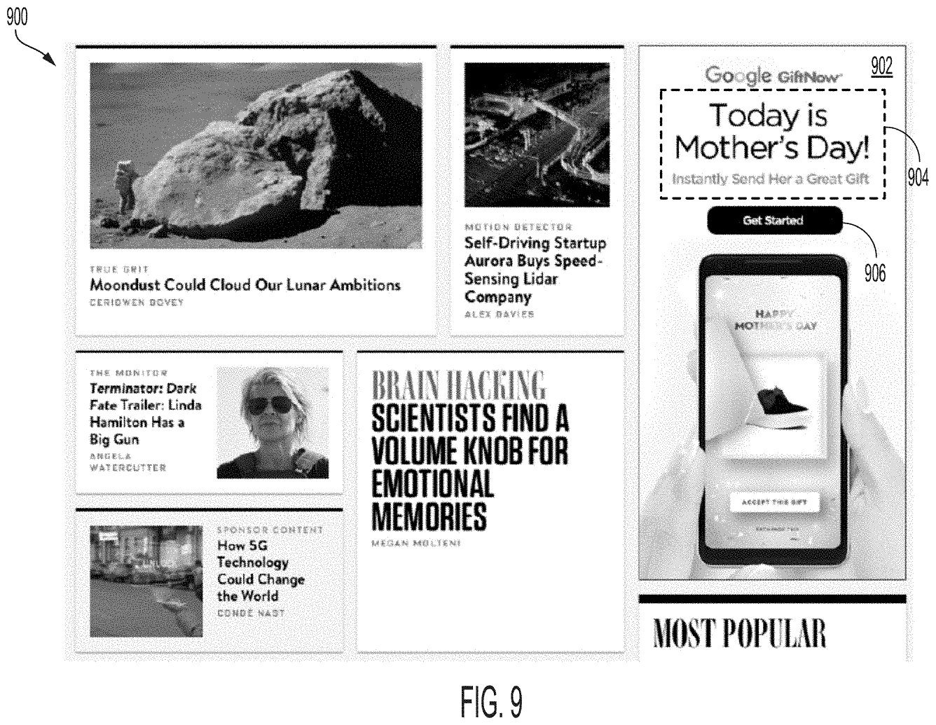

FIG. 9 shows an illustrative example of an environment 900 in which contextual information associated with a user and with a service provider are used to generate an advertisement 902 for generation of a gift object in accordance with at least one embodiment. In the environment 900, a user has used a browser application or other application implemented on its user device to access a news aggregator, through which the user may be presented with various articles from different publishers and/or other websites. For example, as illustrated in FIG. 9, various articles corresponding to the user's interests may be presented, along with sponsored articles provided by the news aggregator and that may be of interest to the user.

In an embodiment, the gifting distribution system can automatically and in real-time access each of the articles presented by the news aggregator to scrape these articles for one or more contextual signals that can be used to determine what contextual information and products may be presented to the user as gift ideas in a gift advertisement 902. For example, the gifting distribution system may access the website or page corresponding to each presented article to scrape the article and identify the publication date of the article. As an illustrative example, an article provided by the news aggregator may have been published on Mother's Day. This date may serve as a contextual signal that may be used to identify the nearest holiday (e.g., Mother's Day) and to determine a level of urgency for purchasing and delivering a gift to a particular recipient. This contextual signal, as well as other contextual signals associated with the user, one or more retailers, and the other articles presented by the news aggregator may be processed by the gifting distribution system using a contextual analysis algorithm (e.g., a machine learning algorithm) to determine the contextual information 904 that may be presented in a gift advertisement 902.

As illustrated in FIG. 9, the gift advertisement 902 may include contextual information 904 related to the contextual signals detected from the various articles presented by the news aggregator, from the user, and from one or more retailer systems. Further, the contextual information may correspond to the level of urgency detected for purchasing and delivering a gift to a recipient. For example, as illustrated in FIG. 9, the contextual information 904 presented in the gift advertisement 902 may indicate that the user may send a gift to a female recipient (e.g., “Instantly Send Her a Great Gift”). Further, based on the level of urgency corresponding to the gift advertisement 902 being presented on Mother's Day, the contextual information 904 may provide an indication acknowledging this level of urgency (e.g., “Today is Mother's Day!,” “Instantly Send Her a Great Gift”).

In an embodiment, the gifting distribution system can provide, in the gift advertisement 902, an image that provides a graphical representation of how a gift may be delivered to a recipient, along with customized features according to the contextual information 904 presented in the gift advertisement 902. For example, as illustrated in FIG. 9, the image may include a graphical representation of a recipient holding a mobile device (e.g., smartphone) through which a gift delivered to the recipient may be displayed. The gift displayed on the mobile device may include product information corresponding to the contextual information 904 presented in the gift advertisement 902. For example, as illustrated in FIG. 9, the gift may include a “Happy Mother's Day” greeting, which may correspond to the contextual information 904 indicating “Today is Mother's Day!” This may allow the user to determine how a gift may be presented to the recipient.

Additionally, the image may include a graphical representation of a product that may serve as a gift idea for the user. As noted above, the gifting distribution system may obtain, from one or more retailer systems, product information that may be used to determine what product may be presented in the gift advertisement 902 as a gift idea. The product information may include images of products, any sales or discounts applied to the products, the MSRP of the products, availability or stock information associated with the products, shipping information associated with the products, and the like. The gifting distribution system may use this product information, as well as any contextual signals related to the user to identify one or more products that may be presented in the gift advertisements 902. For example, the gifting distribution system may use purchase data associated with the user and corresponding to previous purchases made for Mother's Day to identify a possible gift idea that may be presented to the user. As another example, the gifting distribution system may use comments or posts previously submitted by the user via social media and related to Mother's Day to identify a possible gift idea that may be presented to the user through the image.

As illustrated in FIG. 9, the gift advertisement 902 may include a GUI button or other interface element that allows the user to get started with purchasing and delivering a gift to a recipient. For example, as illustrated in FIG. 9, the gift advertisement 902 may include a “Get Started” GUI button that, if selected, may redirect the user to a standalone website or page provided by the gifting distribution system for selecting a product that may serve as a gift that may be delivered to a particular recipient. It should be noted that while the GUI button illustrated in FIG. 9 may redirect the user to a standalone website or page provided by the gifting distribution system, the GUI button may be configured to redirect a user to a retailer website or page provided by the retailer that may provide various products from which the user may select a gift for delivery to a recipient and through which the gift may be purchased directly.

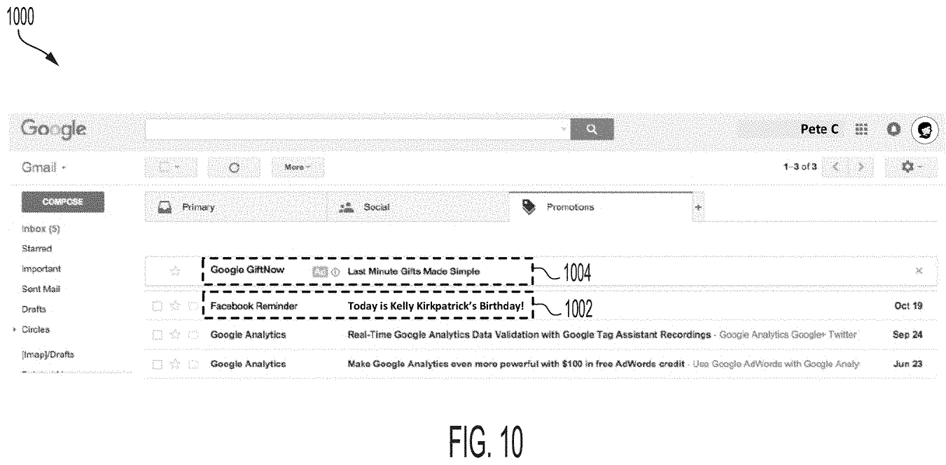

FIG. 10 shows an illustrative example of an environment 1000 in which contextual information obtained from one or more e-mail messages 1002 are used to generate an advertisement 1004 for generation of a gift object in accordance with at least one embodiment. In the environment 1000, a user has used a browser application or other application implemented on their user device to access an electronic mail service through which the user may access their electronic messages and send electronic mail messages to other users. For example, as illustrated in FIG. 10, the user may access an inbox through which the user may review any newly received electronic messages. Further, through the inbox and for each received electronic message, the user may be presented with the name of the sender and a short subject line that may provide context for the received electronic message. As an illustrative example and as illustrated in FIG. 10, the user may have received a new electronic message from “Facebook Reminder,” which may include a reminder that it is the birthday of one or the user's friends (e.g., “Today is Kelly Kirkpatrick's Birthday!”). Thus, through the inbox, the user may immediately determine that they have received a reminder with regard to their friend's birthday.

In an embodiment, the gifting distribution system can, in real-time, scrape the user's inbox to obtain one or more contextual signals that can be processed in order to determine whether to surface a gift advertisement 1004 that the user may select to generate a gift for a particular recipient. For instance, the user may execute a browser extension associated with the gifting distribution system and that is configured to scrape data from their inbox in order to detect any contextual signals that may be used to determine whether to surface a gift advertisement 1004. The data scraped from the inbox may be processed using a contextual analysis algorithm (e.g., the contextual analysis algorithm 108 described above in connection with FIGS. 1, 2, and 3A-3B). The output of the contextual analysis algorithm may include an indication as to whether the gifting distribution system is to surface a gift advertisement 1004 to the user within their inbox and as to the contextual information that may be provided within the gift advertisement 1004.

As an illustrative example, the gifting distribution system may scrape the electronic message 1002 to obtain electronic mail data corresponding to an upcoming birthday of one of the user's friends. This electronic mail data may include the subject line of the electronic mail message 1002, the content of the electronic mail message (e.g., any text or other content within the body of the electronic mail message, etc.), as well as information corresponding to the sender. In an embodiment, based on the identity of the sender, the gifting distribution system can access a website or page provided by the sender to obtain additional information that may be used to identify contextual signals associated with the electronic mail message. For example, the gifting distribution system may access a social media platform in response to a determination that the sender of the electronic mail message 1002 is associated with a social media platform. Through the social media platform, the gifting distribution system may obtain the user's posts, comments, and any other shared content that may be used to identify any additional contextual signals related to the electronic mail message 1002.

The contextual analysis algorithm may process the electronic mail data corresponding to the electronic mail message 1002, as well as any additional content from other websites or pages associated with the sender (e.g., social media posts, comments, etc.), to detect one or more contextual signals and to identify contextual information that may be included in a gift advertisement 1004 to be presented to the user through their inbox. For example, the subject line of the electronic mail message 1002 may include a contextual signal corresponding to an upcoming event (e.g., “Kelly Kirkpatrick's Birthday”), as well as the level of urgency for obtaining a gift for the event (e.g., “Today”). Further, based on the social media posts and comments exchanged within a social media platform associated with the sender of the electronic mail message 1002, the contextual analysis algorithm may determine whether the user has already purchased a gift for the user, a sentiment of the user with regard to purchasing a gift for the event (e.g., anxious, relieved, etc.), and the like. Thus, the contextual analysis algorithm may use these social media posts and comments exchanged within the social media platform to supplement the contextual signals obtained from the electronic mail message 1002 and to determine whether to surface a gift advertisement 1004 for the upcoming event.

Based on the contextual information provided by the contextual analysis algorithm, the gifting distribution system can generate and present a gift advertisement 1004 that is contextually related to the original electronic mail message 1002. For example, as illustrated in FIG. 10, the gift advertisement 1004 may be presented as a new electronic mail message, with a subject line corresponding to the contextual information provided by the contextual analysis algorithm and associated with the original electronic mail message 1002. For example, because the original electronic mail message 1002 corresponds to a contemporaneous event (e.g., a birthday occurring today, etc.), the gift advertisement 1004 may include a subject line that provides a temporal context related to the contemporaneous event (e.g., “Last Minute,” etc.). In some instances, the gift advertisement 1004 may include additional elements to distinguish the gift advertisement 1004 from other electronic mail messages within the user's inbox. For example, the gift advertisement 1004 may be presented with an icon or other graphical element that clearly denotes that the electronic mail message is an advertisement from the gifting distribution system. Further, as illustrated in FIG. 10, the gift advertisement 1004 may be presented within a “Promotions” tab of the user's inbox, separate from the user's other electronic mail messages. Thus, the user may immediately identify the gift advertisement 1004 as being an advertisement for purchasing a gift related to the event indicated in the electronic mail message 1002.

If the user selects the gift advertisement 1004, the user may be presented with an electronic mail message, generated by the gifting distribution system, that provides additional information that may allow the user to purchase and deliver a gift to a recipient. For example, the electronic mail message corresponding to the gift advertisement 1004 may include an image of a product that may serve as a gift idea that may be purchased and delivered to a particular recipient (e.g., the subject of the electronic mail message 1002, etc.). Further, the electronic mail message corresponding to the gift advertisement 1004 may include the contextual information related to the contextual signals detected from the presented article and from the user. This contextual information may be similar to that presented in the gift advertisement 1004 created by the gifting distribution system and presented in the user's inbox. For example, the contextual information may be associated with the level of urgency detected from the electronic mail message 1002 (e.g., “Today is Kelly Kirkpatrick's Birthday!”).

Similar to the gift advertisement described above in connection with FIGS. 5A-5B, the electronic mail message corresponding to the gift advertisement 1004 may include a GUI button or other interface element that allows the user to select the presented gift idea. If the user selects this GUI button or other interface element within the electronic mail message, the user may be redirected to a retailer website or page provided by the retailer through which the gift idea may be purchased directly. In some instances, if the user selects the GUI button or other interface element, the user may be redirected to a standalone website or page provided by the gifting distribution system, through which the user may purchase a gift and request deliver of the gift to a particular recipient, as described above.

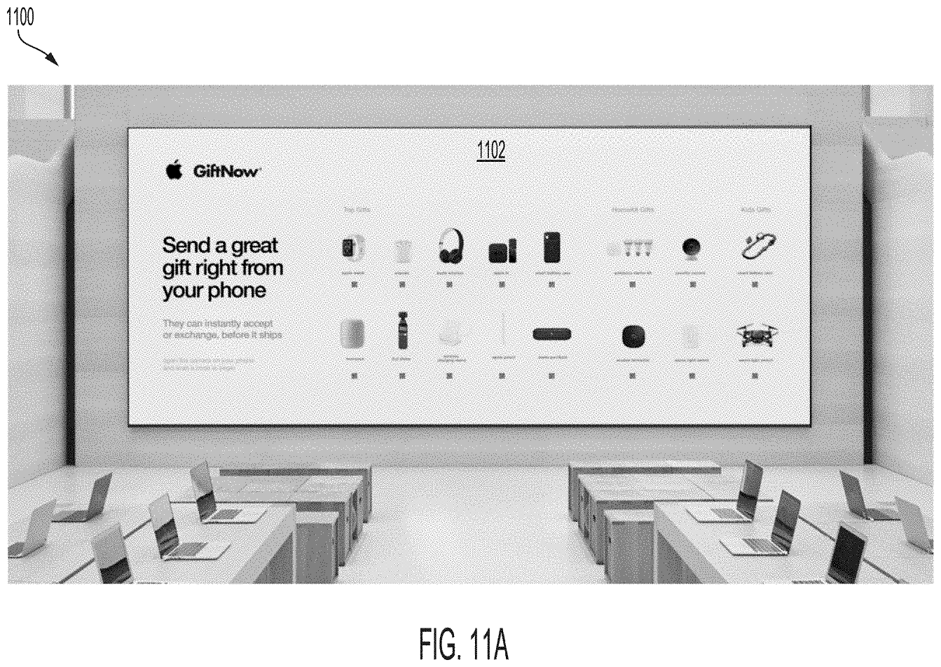

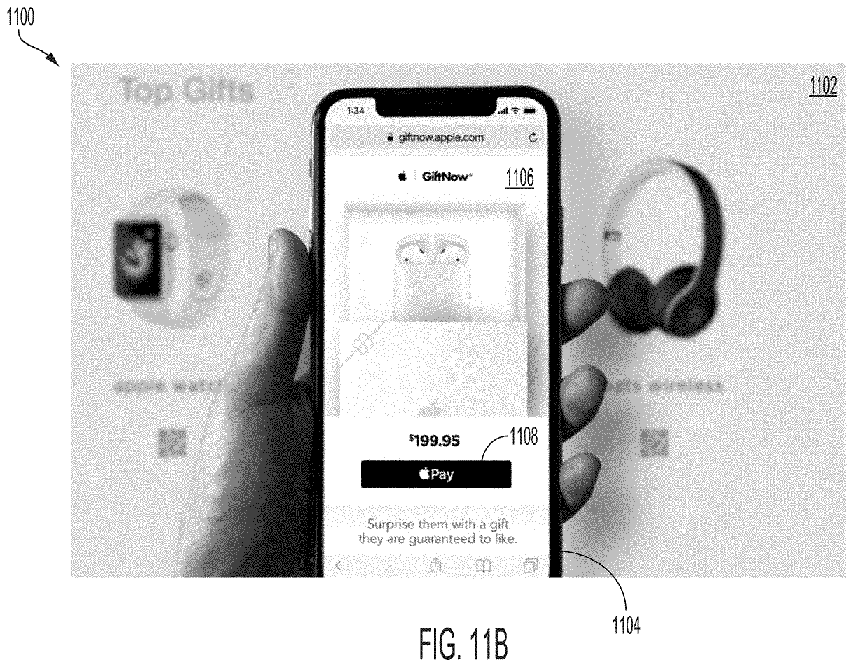

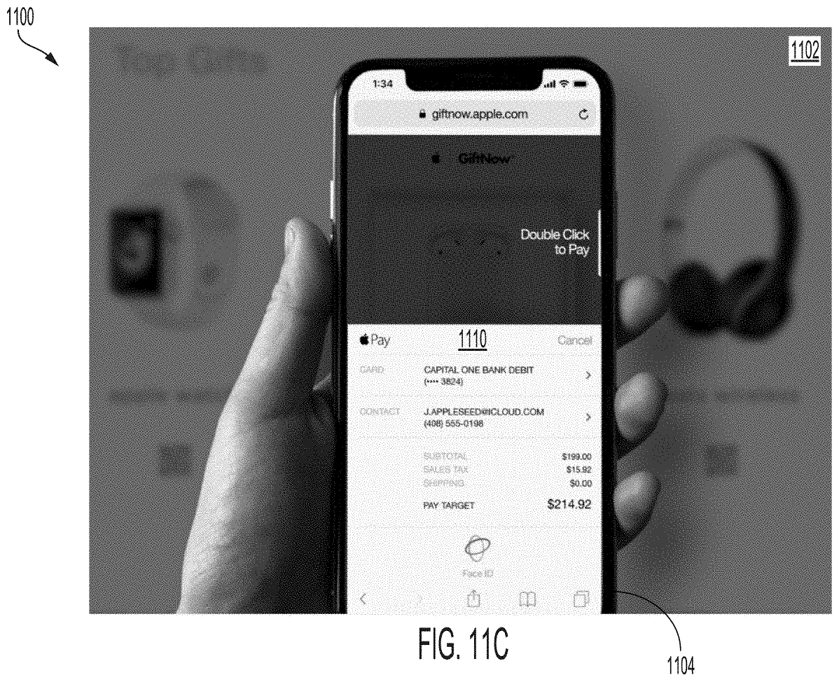

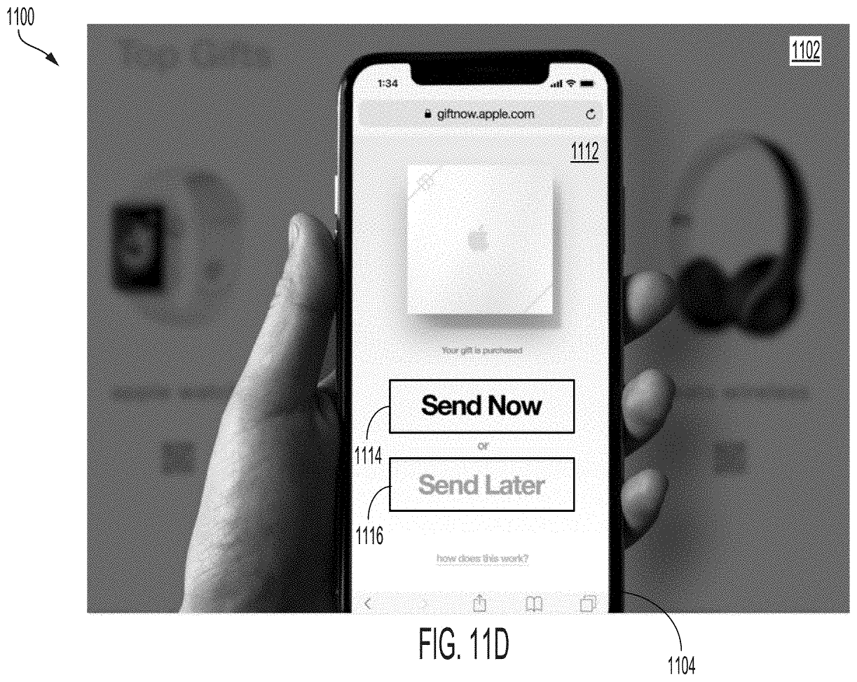

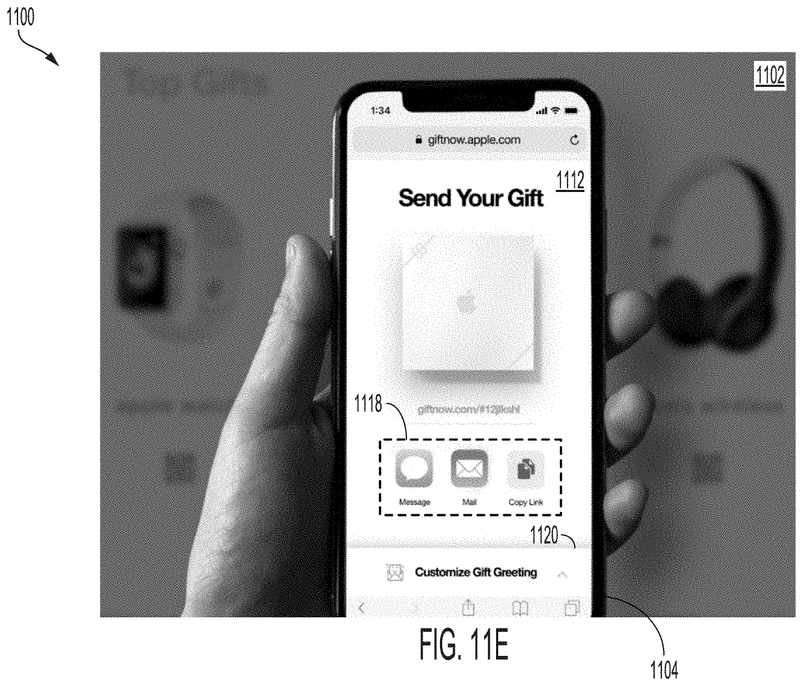

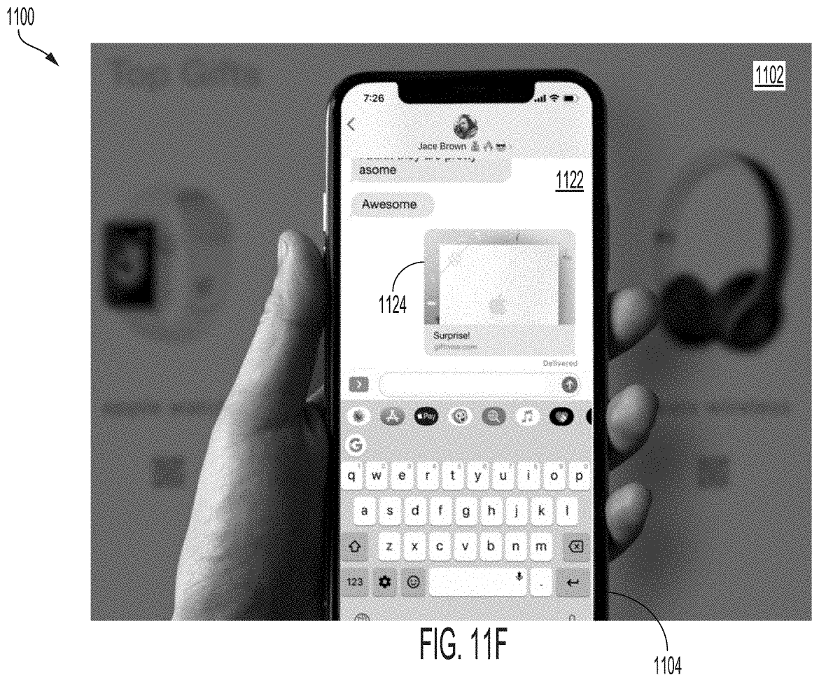

FIGS. 11A-11F show an illustrative example of an environment 1100 in which a user device is used to interact with an advertisement 1102 presented at a point-of-sale to generate a gift object for delivery to a recipient in accordance with at least one embodiment. In the environment 1100, a retailer may present, at a point-of-sale (e.g., store, kiosk, office, etc.) a gift advertisement 1102 generated by a gifting distribution system. The gift advertisement 1102 may include various gift ideas corresponding to products that may be sold by the retailer and that may be delivered to recipients as gifts. In an embodiment, to generate the gift advertisement 1102, the gifting distribution system obtains product information and other information that may serve as contextual signals from one or more retailer systems associated with the retailer. For instance, the gifting distribution system may obtain sales records related to products sold by the retailer at the point-of-sale in order to determine which products are often sold at the point-of-sale. Additionally, the gifting distribution system may obtain any sale/discount information for products offered at the point-of-sale, as well as any schedules related to the sale/discount (e.g., beginning date of the sale/discount, end date of the sale/discount, etc.). The product information obtained through the one or more retailer systems may include images of the one or more products that may be presented in the gift advertisement 1102, pricing details of the one or more products (e.g., sales prices, discounts, MSRP, etc.), configuration options for the one or more products, and the like.

In an embodiment, the product information and other information obtained from the one or more retailer systems are processed using the aforementioned contextual analysis algorithm (e.g., the contextual analysis algorithm 108 described above in connection with FIGS. 1, 2, and 3A-3B)) to obtain contextual information that may be presented within the gift advertisement 1102. For example, based on the product information and other information obtained from the one or more retailer systems, the contextual analysis algorithm may generate contextual information corresponding to upcoming or ongoing sales/discounts for one or more products that are to be presented in the gift advertisement 1102. Additionally, or alternatively, the contextual analysis algorithm may identify popular products that are low in stock or being purchased at a high rate. The contextual analysis algorithm may provide contextual information that corresponds to a level of urgency for purchasing these products as gifts (e.g., “Don't Delay! Once This Product Is Gone, It's Gone!,” etc.).

In an embodiment, the gifting distribution system can augment the gift advertisement 1102 to provide a code for each offered product. The code may be implemented as a Quick Response (QR) code, a barcode, or other machine-readable label that may encode information that may be scanned and processed by a user device (e.g., smartphone, etc.). For instance, the code presented in the gift advertisement 1102 may encode executable instructions that, when executed by a user device, may cause the user device to execute a browser application or other application to access a product detail page or a standalone page associated with the gifting distribution system in order to purchase and deliver a gift to an intended recipient. For example, as illustrated in FIG. 11A, each gift idea presented in the gift advertisement 1102 may include a corresponding QR code that, if scanned using a user device at the point-of-sale, may cause the user device to execute a browser application, through which the user may be directed to and access a standalone website or page provided by the gifting distribution system through which the user may purchase the product and have the product delivered to a recipient as a gift.

As illustrated in FIG. 11B, a user may use its user device 1104 to scan a QR code associated with a particular product presented in the gift advertisement 1102 to access a website 1106 corresponding to the particular product. The website 1106 may be provided as a standalone page created by the gifting distribution system through which the user may purchase the product and have the product delivered as a gift to a particular recipient. The standalone page may be provided without any tie to the retailer or to a product detail page provided by the retailer for the selected product. As noted above, the gifting distribution system may obtain product information corresponding to the selected product from the one or more retailer systems. Thus, the standalone page may include product information such as images of the product, sizing options, color options, customization options, MSRP, actual sales prices, shipping costs, estimated taxes, and the like. However, unlike the product detail page provided by a retailer, the standalone website or page may be devoid of any branding or other information corresponding to the retailer from which the products may be sourced. Further, through the standalone website or page, the user may interact directly with the gifting distribution system rather than through a retailer.

In some instances, the website 1106 may be a product detail page generated by the retailer and corresponding to the selected product. The product detail page may include product information maintained by the retailer. Further, in some instances, the product detail page may be augmented with one or more gift options and/or images provided by the gifting distribution system. For example, as illustrated in FIG. 11B, the website 1106 may include an image of the product superimposed on an image of a gift box that bears the logo or trademark of the retailer from which the product may be purchased. The product detail page may further include pricing information for the product and a purchase GUI button 1108, which the user may select to submit a request to purchase the product as a gift.

If the user selects the purchase GUI button 1108, the display of the user device 1104 may be updated to present a payment page 1110, as illustrated in FIG. 11C. Through the payment page 1110, the user may select their payment method for the gift, provide their contact information for the purchase, and review an invoice for the purchase of the product. If the user selects an option from the payment page 1110 to proceed with payment for the product, the payment may be authorized and processed by either the gifting distribution system or the retailer through one or more payment systems. For instance, the gifting distribution system or the retailer may transmit transaction information related to the purchase of the particular product through the one or more payment systems, as described above.

Once the payment for the particular product has been authorized and processed, the gifting distribution system may redirect the user to a web site 1112 through which the user may be presented with one or more options 1114-1116 for delivery of the product as a gift to a recipient. For example, as illustrated in FIG. 11D, the gifting distribution system may provide the user, through the user device 1104, with an option 1114 to deliver the product to a recipient immediately. Further, the gifting distribution system may provide the user with an option 1116 to deliver the product to a recipient at a later time. For example, based on the contextual signals and contextual information, the gifting distribution system may provide the user with an option to purchase the gift immediately but to digitally deliver the gift at a later time, such as on a recipient's birthday as indicated by the user or otherwise determined based on the contextual signals from the user device 1104. In some instances, the gifting distribution system may obtain user data from the user device 1104 that may be used to determine which options to surface to the user through the website 1112. For example, the delivery options may be tailored according to the contextual signals related to the user and the retailer from which the gift has been purchased. As an illustrative example, if the user purchases the product in response to a last minute message provided by the retailer to its customers after a shipping cutoff, the gifting distribution system may focus the delivery options on digital delivery as the primary delivery or fulfillment option. As another example, if the user has indicated (e.g., via comments, posts, electronic messages, etc.) that they have a short time window to obtain and deliver a gift to the recipient, the gifting distribution system may focus the delivery options on expedited and digital shipping options.

As illustrated in FIG. 11E, the user may be presented with one or more gift delivery options 1118 corresponding to the option 1114-1116 selected. For example, the gift delivery options 1118 presented in FIG. 11E may correspond to digital delivery options available to the user and may be presented in response to selection of the “Send Now” option 1114 described above and illustrated in FIG. 11D. These digital delivery options may include an option to transmit a text or other Short Message Service (SMS) message to the recipient that includes a unique link to the gifting distribution system. Using the link, the recipient may access the gifting distribution system and redeem the gift purchased by the user. Further, the recipient may be able to select any available customization options for the gift, if available. The digital delivery options may further include an option to transmit an electronic mail message to the recipient that includes the unique link to the gifting distribution system. In some instances, the digital delivery options may include an option to copy the link generated by the gifting distribution system. This may allow the user to share the link with the recipient using any available method through the user device 1104.

In addition to the gift delivery options 1118 presented on the website 1112, the gifting distribution system may provide the user with an option 1120 to customize a gift greeting that may be included with the gift. If the user selects the option 1120, the gifting distribution system may allow the user to define, through the website 1112, a greeting (e.g., “Happy Birthday!,” “Congratulations!,” etc.) that may be included with the gift in a digital/electronic message to the recipient. In some instances, selection of the option 1120 may cause the gifting distribution system to present additional options for additional services through which a greeting may be provided with the gift. For example, if the user has selected a gift option from the option 1120 to include a customized card with the gift, the gifting distribution system may coordinate with a greeting card service provider to provision the customized card that is to be included with the gift. This option may be provided based on the gift delivery option selected by the user. For example, the option may be omitted if the user has selected a digital/electronic method for delivering the gift to the recipient. In some instances, if delivery of the gift is to be performed by a particular date (e.g., date of an event, etc.), the gifting distribution system may forego presentation of an option to obtain a customized greeting card from a greeting card service provider if it is estimated that the customized greeting card cannot be obtained in time. Thus, the options presented in response to selection of the customize gift greeting option 1120 may be tailored according to the gift delivery option selected and the amount of time available for delivery of the gift.

As illustrated in FIG. 11F, the user has selected the option to transmit a SMS message 1124 to the recipient that includes the link to the purchased gift. As a result of the user having selected this option, the gifting distribution system may transmit executable instructions to the user device 1104 to execute a text message application on the user device 1104. Through the text message application, the gifting distribution system may transmit a link associated with the gift to the recipient using the contact information provided by the user for the recipient. The user, through a display 1122 associated with the text message application, may see the SMS message 1124 sent to the recipient. The SMS message 1124 may include an image of a gift (e.g., gift box, as illustrated in FIG. 11F), as well as a greeting as either defined by the user through selection of the customize gift greeting option 1120 or defined by default by the gifting distribution system. Thus, the gift may be automatically transmitted to the recipient digitally and according to the user's selections and instructions.

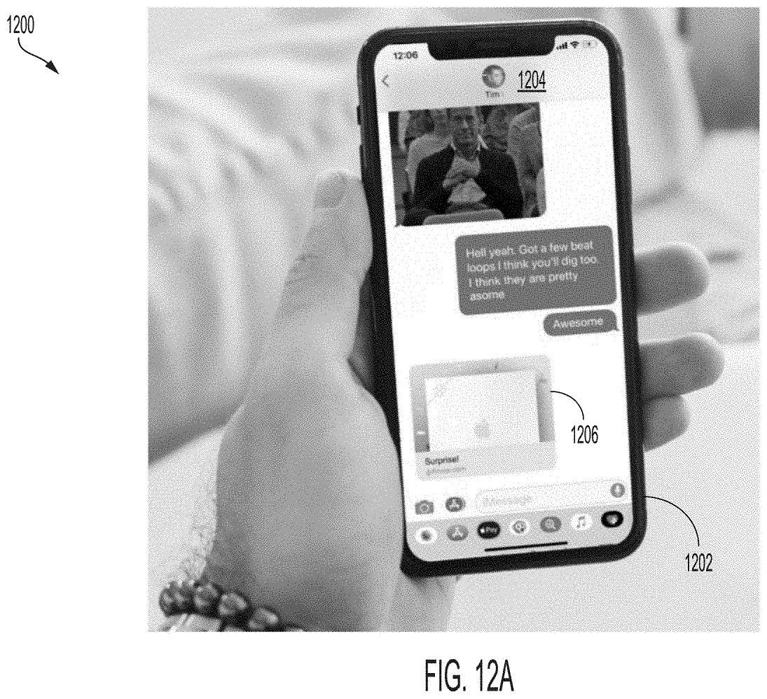

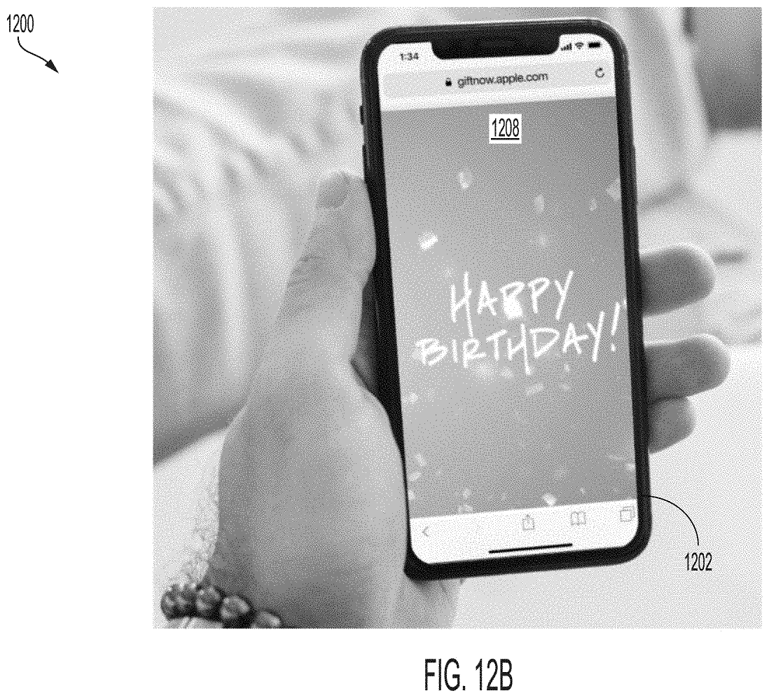

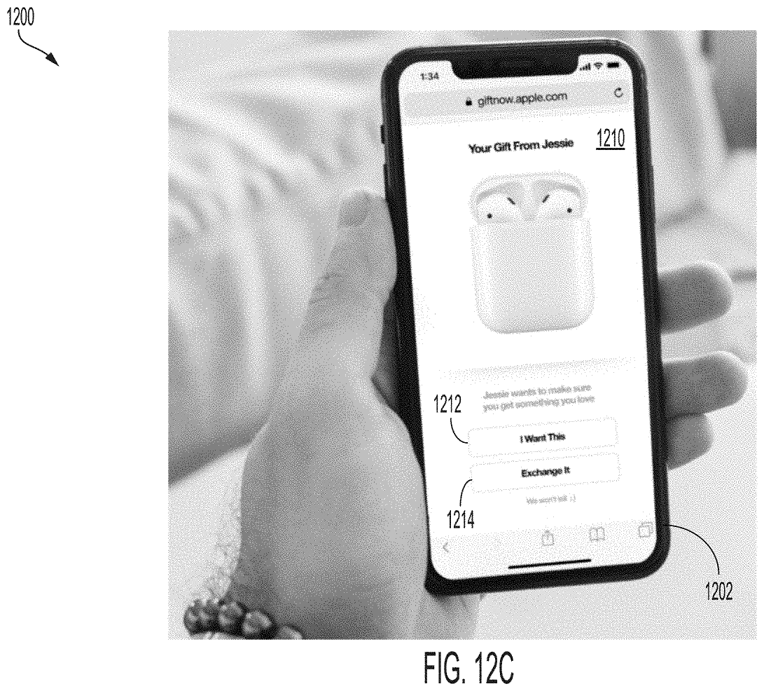

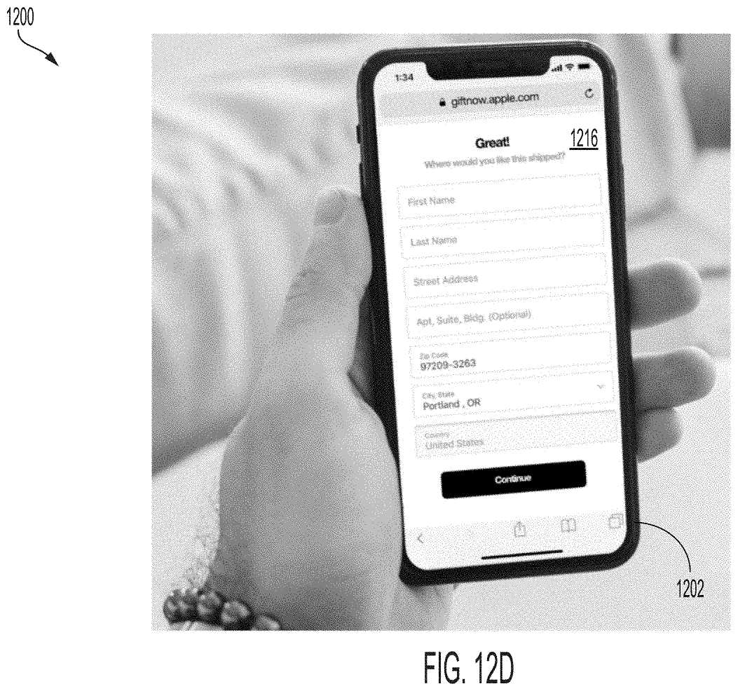

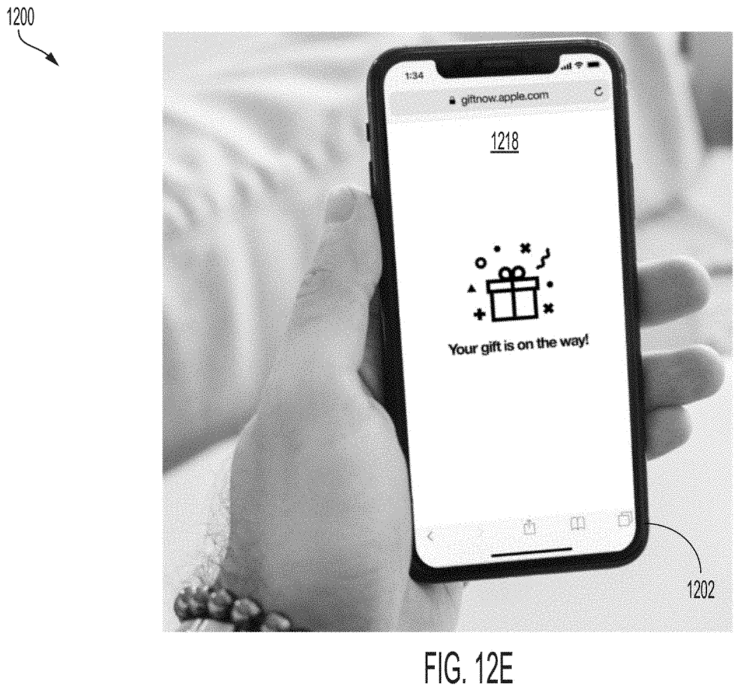

FIGS. 12A-12E show an illustrative example of an environment 1200 in which a recipient of a gift object interacts with the gift object through a user device 1202 to request delivery of a particular gift in accordance with at least one embodiment. The environment 1200 may correspond to a recipient perspective related to the receipt of a gift delivered via a text messaging application by a gifting distribution system in response to user selection of a product at a point-of-sale, as illustrated and described above in connection with FIGS. 11A-11F. In the environment 1200, the recipient may receive a notification, through their user device 1202, of a newly received SMS message 1206. In response to this notification, the recipient may access their text messaging application 1204 implemented on the user device 1202 to view the SMS message 1206. As noted above, the SMS message may include an image of a gift (e.g., gift box, as illustrated in FIGS. 11F and 12A), as well as a greeting as either defined by the user (e.g., sender) through selection of the customize gift greeting option 1120 (as illustrated in FIG. 11E) or defined by default by the gifting distribution system.

As illustrated in FIG. 12A, the recipient may review the SMS message 1206 to determine that they have received a gift from the sender. Further, through the text messaging application 1204, the recipient may select the SMS message 1206 corresponding to the gift in order to redeem the gift. For example, the recipient may tap on the SMS message 1206 corresponding to the received gift in order to access the gifting distribution system. As noted above, the SMS message 1206 may include or otherwise be associated with a unique link that may correspond to the gift purchased by the sender. Thus, selection of the SMS message 1206 may result in invocation of the link. Invocation of the link may cause a browser application implemented on the user device 1202 to access a website or page corresponding to the link.

As illustrated in FIG. 12B, selection of the SMS message 1206 may redirect the recipient to a landing page 1208 through which the recipient may be presented with a greeting selected by the sender or otherwise provided by default by the gifting distribution system. For example, in response to selection of the SMS message 1206, the recipient may be presented with a landing page 1208 that includes an image or multimedia content acknowledging the recipient's birthday. This may provide the recipient with an indication as to the occasion for which the gift was provided to the recipient.

From the landing page 1208, the recipient may select the greeting to view the gift and select an option to either redeem the gift or to exchange the gift for a different product provided by the retailer associated with the gift or by the gifting distribution system. For example, in response to selection of the greeting or after a pre-defined period of time, the recipient may be redirected to a website 1210 corresponding to the gift as illustrated in FIG. 12C. Through the website 1210, the recipient may be provided with product information associated with the selected gift. For example, the recipient may be provided with an image of the gift, specifications of the gift, any available customization options for the gift (e.g., sizing options, color options, etc.), and the like.

As illustrated in FIG. 12C, the recipient may be provided with an option 1212 to accept the gift and an option 1214 to exchange the gift for another product offered by a retailer or the gifting distribution system. If the user selects the option 1214, the gifting distribution system may update the website 1210 to present the recipient with one or more options for exchanging the received gift with an alternative product or with a gift card having a value corresponding to the value of the gift that is to be exchanged or otherwise to the amount paid by the sender when purchasing the gift for delivery to the recipient. The one or more options that may be presented to the recipient may be generated based on product information from one or more retailer systems associated with a retailer from which the gift was obtained. For example, returning to the original gift advertisement illustrated in FIG. 11A, the gifting distribution system may identify the other products presented in the gift advertisement and present these to the recipient as possible alternative products that may be selected. Alternatively, the gifting distribution system may present other products made available by the original retailer associated with the gift and/or other retailers with which the gifting distribution system may maintain a connection. For instance, the gifting distribution system may obtain product information from retailer systems associated with other retailers to identify products that may serve as alternative options for the recipient. In some instances, the gifting distribution system may use user data associated with the recipient (e.g., clickstream data, search data, purchase data, user profile data, etc.), as well as product information from the various retailer systems, as input to a machine learning algorithm (e.g., the contextual analysis algorithm, the gift options algorithm, etc.) to identify possible alternative product options that may be presented to the recipient for the exchange.

If the recipient selects the option 1212 to request delivery of the received gift, the gifting distribution system may redirect the recipient to a website 1216, through which the recipient may be prompted to select a method of delivery and to provide delivery information corresponding to the selected method of delivery. For example, if the recipient has opted to have the gift delivered digitally to the recipient (if possible), the gifting distribution system may prompt the recipient for an electronic address (e.g., electronic mail address, username associated with a social media account, etc.) where the gifting distribution system may transmit the gift to complete the delivery. If the recipient opts to have the gift physically delivered to them, the gifting distribution system may prompt the recipient, via the website 1216, to provide a physical mailing address and any other information that may be required to ensure that the gift is delivered to the recipient. For example, as illustrated in FIG. 12D, the gifting distribution system may prompt the recipient to provide their name and physical address for delivery of the gift. In some instances, the gifting distribution system may additionally prompt the recipient to provide their contact information (if not previously provided by the sender) for the delivery.

Once the recipient has selected a gift for delivery and has provided their delivery information, the gifting distribution system may provide the recipient with a confirmation notification to indicate that the request to deliver the gift has been received. For example, as illustrated in FIG. 12E, the gifting distribution system may dynamically update the website to present a notification 1218 that serves as an indication that the request has been received and that the gift will be delivered to the recipient.

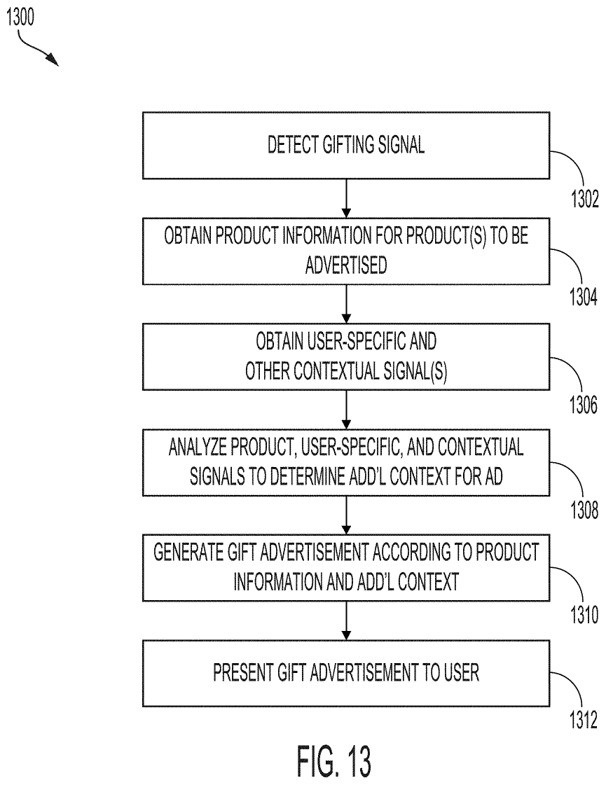

FIG. 13 shows an illustrative example of a process 1300 for using contextual information to generate and present a gift advertisement in accordance with at least one embodiment. The process 1300 may be performed by the gift advertisement sub-system in conjunction with the machine learning system described above. At step 1302, the gift advertisement sub-system may detect a gifting signal that may serve as an indication to generate a gift advertisement that may be presented to a user. The gifting signal may include a request from a retailer system to generate a gift advertisement that is to be presented to users accessing a particular website. In some instances, the gifting signal may be generated by an advertisement service provider through which website publishers are subscribed in order to prevent relevant advertisements to users accessing a particular website. For example, a website publisher may subscribe to the advertisement service provider to serve advertisements, including gift advertisements, on its website. The advertisement service provider may coordinate with the gift advertisement sub-system to request creation of a gift advertisement that may be presented to a user accessing the webpage. This request may serve as a gifting signal.

At step 1304, the gift advertisement sub-system may obtain product information for one or more products that are to be advertised via the gift advertisement. For instance, the gift advertisement sub-system may query one or more retailer systems associated with a retailer to obtain product information corresponding to different products offered by the retailer and that may serve as gift ideas. The product information may include images of the one or more products, pricing details of the one or more products (e.g., sales prices, discounts, MSRPs, etc.), sizing or color options for the one or more products, and the like. Further, from the one or more retailer systems, the gift advertisement sub-system may identify which of the products offered by the retailer may be presented as gift ideas. For example, the retailer may indicate which products may be advertised in gift advertisements.

In an embodiment, the product information may be automatically pushed to the gift advertisement sub-system by the one or more retailer systems. This may obviate the need for the gift advertisement sub-system to query the one or more retailer systems to obtain the product information for products that may be advertised as gift ideas to users. In some instances, the gift advertisement sub-system may store product information associated with products that may be advertised through gift advertisements in a product information repository. This may allow the gift advertisement sub-system to select which products are to be advertised and obtain, from this repository, product information corresponding to these products. In some instances, the gift advertisement sub-system may still query the one or more retailer systems to ensure that the gift advertisement sub-system has the current product information for these products and that these products may still be advertised in a gift advertisement.

At step 1306, the gift advertisement sub-system may obtain user-specific and other contextual signals that may be used to identify additional contextual information that may be included in the gift advertisement. As noted above, the gift advertisement sub-system may use a cookie and/or browser extension to obtain data about the user that may be used to generate a gift advertisement that is tailored to the user. Through the cookie and/or the browser extension, the gift advertisement sub-system may collect clickstream data, search data, purchase data, user profile data, and other data that may be associated with the user. Additionally, the gift advertisement sub-system may evaluate the website being accessed to obtain one or more contextual signals that may be used to generate the gift advertisement. For example, if the user navigates to a website that includes a news article that was updated at or near Mother's Day, the gift advertisement sub-system may automatically detect a contextual signal associated with Mother's Day. As another illustrative example, if the user navigates to an online calendar or inbox, the gift advertisement sub-system may scrape the online calendar or inbox to identify any contextual signals corresponding to user-specific events (e.g., a friend's birthday, an upcoming baptism for a nephew, an upcoming Bar/Bat Mitzvah for a sibling, etc.) that may be used to determine what contextual information may be provided in a gift advertisement, as well as what gift ideas may be presented through the gift advertisement.

At step 1308, the gift advertisement sub-system may use a machine learning system to analyze the product information and the user-specific and other contextual signals detected by the gift advertisement sub-system to determine the additional contextual information that may be included in the gift advertisement. For instance, the gift advertisement sub-system may provide contextual signals obtained from the user device (such as through the browser application and/or other applications), the website or other content accessed by the user, and any other information garnered from the user (such as through the cookie or browser extension) and/or one or more retailer systems to a machine learning system to determine the contextual information that may be presented to the user through a gift advertisement. As noted above, the machine learning system may use the user information, product information, and contextual signals as input to determine the contextual content that is to be included in a gift advertisement that is to be presented to the user. Returning to the example described above in connection with FIG. 1, if the contextual signals and other information correspond to Mother's Day and an urgent need to purchase a gift for a recipient for Mother's Day, the machine learning system may output contextual content that is related to Mother's Day and that expresses to the user that they should not delay in purchasing a gift for Mother's Day. As another illustrative example, if the contextual signals and other information correspond to a recipient's upcoming birthday and the user has been researching various video games for the recipient, the machine learning system may output contextual content that is related to the recipient's birthday and that includes product information related to one or more video games that the recipient may be interested in based on the user's research.

At step 1310, the gift advertisement sub-system may generate a gift advertisement according to the product information obtained from the one or more retailer systems and/or from the product information repository and the additional contextual information/content provided by the machine learning system. As noted above, a gift advertisement may include various elements that allow a user to review the proposed gift idea(s) and to select the gift advertisement in order to access a product detail page or a standalone page associated with the gifting distribution system in order to purchase and deliver a gift to an intended recipient. For example, a gift advertisement may include an image, digital video, or other visual element associated with one or more products that may be available for purchase and delivery as a gift. Additionally, the gift advertisement may include contextual information that may be relevant to the user based on contextual signals received by the gift advertisement sub-system. For example, if the gift advertisement is being presented within a small window of time prior to Thanksgiving, the gift advertisement may include contextual information associated with Thanksgiving and convey a sense of urgency in purchasing a gift ahead of the holiday.

The gift advertisement may further include one or more interaction elements that may be selected to access a product detail page or a standalone page associated with the gifting distribution system in order to purchase and deliver a gift to an intended recipient. For example, the one or more interaction elements may include a GUI button that provides a signal to the user to select the button in order to purchase a gift for a recipient. The GUI button, for example, may include text such as “Gift Now!,” “Get Started!,” “Get Him a Gift!,” or other similar text that may be indicative of a gift creation process.

At step 1312, the gift advertisement sub-system may present the gift advertisement to the user. For instance, the gift advertisement may be presented within a banner or frame on a website that the user has accessed. As another example, if the gift advertisement was generated based on content presented in a video or other form of multimedia, the gift advertisement sub-system may present a gift advertisement within the video or other form of multimedia or as a standalone advertisement within the website through which the video or other form of multimedia is being accessed. As yet another example, if the gift advertisement was generated based on content presented within a user's calendar or inbox, the gift advertisement may be presented within the calendar or inbox, as described above.

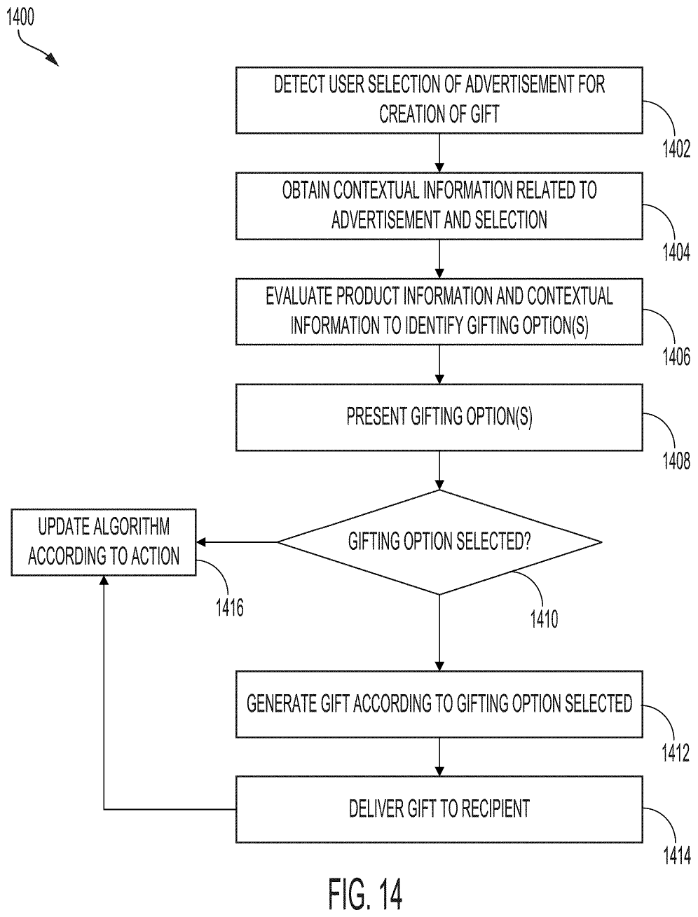

FIG. 14 shows an illustrative example of a process 1400 for using contextual information to identify and present one or more gifting options for creation and delivery of a gift object in accordance with at least one embodiment. The process 1400 may be performed by the gifting distribution system in conjunction with a machine learning system that is configured to surface one or more gift options for purchasing and delivering a gift to a particular recipient. At step 1402, the gifting distribution system may detect user selection of a gift advertisement. For instance, the user may click, tap, or otherwise select a gift advertisement presented through a browser application or other application implemented on a user device to access a product detail page or standalone website/page associated with one or more products presented in the gift advertisement. For instance, if the user selects the contextual gift advertisement, the user may be redirected to a product detail page or standalone page corresponding to the gift advertisement.

At step 1404, in response to the user selection of the gift advertisement, the gifting distribution system may obtain contextual information related to the gift advertisement and to the selection of the gift advertisement. For instance, the gifting distribution system may obtain the contextual information previously generated by the machine learning system during creation of the gift advertisement and presented in the gift advertisement. Further, the gifting distribution system may obtain any new information garnered from the user (e.g., through user interaction with their user device) and/or one or more retailer systems associated with the product detail page or otherwise associated with products presented in the gift advertisement. The new information garnered from the user device may include user data that may be obtained after presentation of the gift advertisement. This user data may be obtained via cookies or a browser extension (e.g., clickstream data, search data, purchase data, user profile data, etc.), data corresponding to content presented on a website or application, data obtained from e-mails or social media posts/comments, and the like. The new information garnered from the retailer system may include messages transmitted by the retailer system to customers related to the products being offered for gifting, shipping cutoff dates, sale/discount cutoff dates, and the like. The gifting distribution system may provide this information to the machine learning system, which may be configured to generate one or more gifting options, as described herein.

At step 1406, the gifting distribution system, through the machine learning system, may evaluate the product information and the contextual information from the gift advertisement, as well as any new contextual signals from the user, to identify one or more gifting option that may be presented to the user. As an illustrative example, if the contextual signals and contextual information correspond to Mother's Day and an urgent need to purchase a gift for a recipient for Mother's Day, the machine learning system may generate gift options for expedited or digital shipping of the gift and for including a Mother's Day card or note with the gift. As another illustrative example, if the contextual signals correspond to the user having a short amount of time to provide a gift to a recipient, the machine learning system may generate a gift option that corresponds to expedited shipping of the gift and/or digital delivery of the gift. As yet another illustrative example, if the contextual signals and contextual information correspond to a recipient's upcoming birthday, the machine learning system may generate gift options that include an option for gift wrapping, an option for including a birthday card with the gift, options corresponding to shipping methods based on the proximity to the actual birthday, and the like.

At step 1408, the gifting distribution system may present the one or more gifting options to the user. As noted above, selection of a gift advertisement may redirect the user to a standalone website or page through which the user may purchase and request delivery of a gift to a particular recipient. The standalone website or page may be provided by the gifting distribution system, which may not be tied to a retailer website or other product detail page associated with a retailer. Alternatively, selection of a gift advertisement may redirect the user to a product detail page, provided by a retailer and corresponding to the one or more products presented through the gift advertisement or otherwise made available by the retailer for the creation of a gift. Through the standalone website/page or product detail page, the gifting distribution system may present one or more gift options for purchasing and delivery of the gift based on the contextual signals and contextual information associated with the gift advertisement, the user device, and the one or more retailer systems that may make available the one or more product options presented on the standalone website or page.

At step 1410, the gifting distribution system may determine whether a gifting option presented to the user was selected. For instance, the gifting distribution system may monitor user interactions with the one or more gifting options presented via the standalone website/page or product detail page to determine whether the user has selected one or more gifting options for creation and delivery of the gift. In some instances, the user may forego selection of any of the provided gifting options, instead opting to define their own parameters for the creation and delivery of the gift. This may serve as an indication that the user has rejected the provided gifting options. Accordingly, at step 1416, the gifting distribution system may use this rejection of the provided gifting options to update the machine learning system (e.g., algorithm). For example, if the user foregoes use of the provided one or more gift options and instead selects a gift using other options manually selected by the user through the product detail page or standalone website/page, the gifting distribution system may provide data corresponding to the user's selection of these other options over those provided by the machine learning system to re-train the gift options algorithm used by the machine learning system to generate gift options. This may decrease the likelihood that the gift options algorithm will provide the one or more previously provided gift options for similar users and/or similar gift advertisements. Further, this re-training of the gift options algorithm may result in the gift options algorithm providing gift options similar to those manually selected by the user for similar users and/or gift advertisements.

If the user selects one or more of the presented gifting options, the gifting distribution system, at step 1412, may generate the gift according to the one or more gifting options selected. As noted above, through the product detail page or standalone web site/page, the user may provide one or more gift selections from the products offered on the product detail page or standalone website/page and from the one or more gift options generated by the gift options algorithm. These one or more gift selections may be processed by a gift creation engine of the gifting distribution system. In an embodiment, the gift creation engine is configured to process the one or more gift option selections made by the user in order to generate the gift according to these selections. For example, the gift creation engine may coordinate with a retailer in order to obtain or otherwise reserve a particular product that is to serve as the gift that is to be delivered to the recipient. Further, the gift creation engine may coordinate with one or more third-party entities in order to prepare the gift according to the selected options. These third-party entities may include gift wrapping service providers, greeting card service providers, and the like. For example, if the user has selected a gift option to include a customized card with the gift, the gift creation engine may coordinate with a greeting card service provider to provision the customized card that is to be included with the gift. The gift creation engine may further process payment for the selected gift. For instance, the gift creation engine may transmit transaction information for purchase of the gift to one or more payment systems for payment authorization and processing.

At step 1414, the gifting distribution system may deliver the gift to the recipient. For instance, once the transaction has been completed, the gifting distribution system may deliver the gift according to the product and gift option selections made by the user. For example, if the gift is to be physically delivered to the recipient, the gifting distribution system may coordinate with a retailer system associated with the gift to ship and deliver the gift to the recipient. If the gift is to be gift-wrapped and/or include a customized card or note (e.g., Mother's Day card, birthday card, etc.), the gifting distribution system may coordinate with the retailer system associated with the gift to ensure that the gift is wrapped and that the requested card or note is included with the gift according to the selected gift options. This may include having the retailer ship the gift to a third-party to perform these additional operations according to the selected gift options.

The gifting distribution system, at step 1416, may provide the selections made by the user to the machine learning system to allow for reinforcement the machine learning system (e.g., algorithm). For example, if the user had selected one or more of the provided gift options, the gifting distribution system may provide data corresponding to the user's selection of these one or more gift options to reinforce the reinforce the gift options algorithm. This may increase the likelihood that the gift options algorithm will provide the one or more previously provided gift options for similar users and/or similar gift advertisements. Further, this reinforcement of the gift options algorithm may result in the gift options algorithm providing gift options similar to those selected by the user for similar users and/or gift advertisements. Thus, as users select gift options for creating a gift for a recipient, the gift options algorithm may be updated continuously, and iteratively, over time.

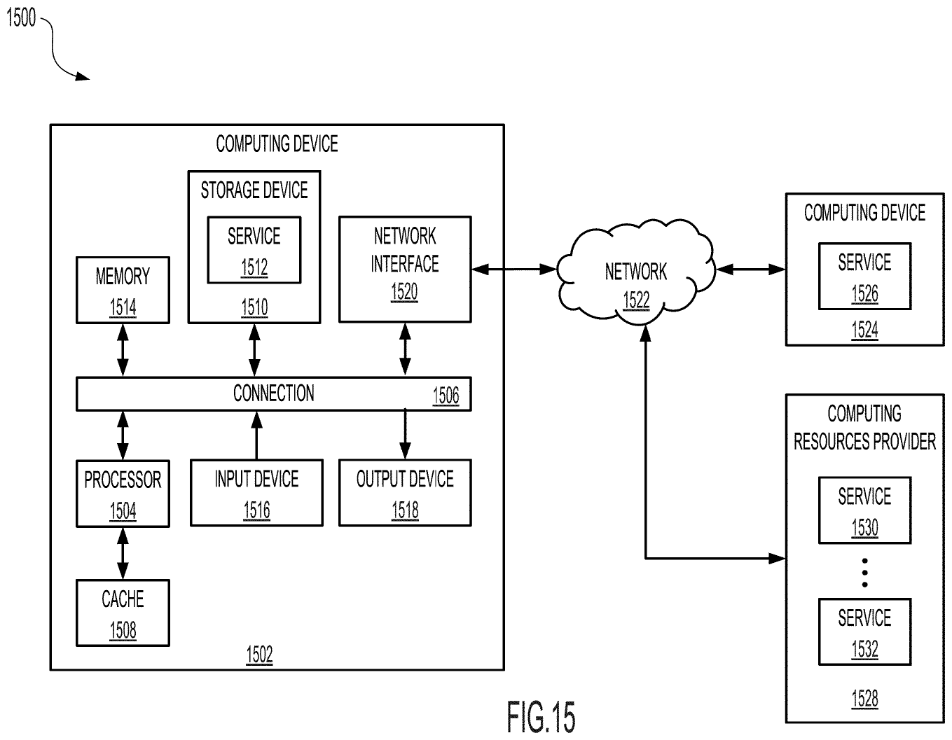

FIG. 15 illustrates a computing system architecture 1500, including various components in electrical communication with each other, in accordance with some embodiments. The example computing system architecture 1500 illustrated in FIG. 15 includes a computing device 1502, which has various components in electrical communication with each other using a connection 1506, such as a bus, in accordance with some implementations. The example computing system architecture 1500 includes a processing unit 1504 that is in electrical communication with various system components, using the connection 1506, and including the system memory 1514. In some embodiments, the system memory 1514 includes read-only memory (ROM), random-access memory (RAM), and other such memory technologies including, but not limited to, those described herein. In some embodiments, the example computing system architecture 1500 includes a cache 1508 of high-speed memory connected directly with, in close proximity to, or integrated as part of the processor 1504. The system architecture 1500 can copy data from the memory 1514 and/or the storage device 1510 to the cache 1508 for quick access by the processor 1504. In this way, the cache 1508 can provide a performance boost that decreases or eliminates processor delays in the processor 1504 due to waiting for data. Using modules, methods and services such as those described herein, the processor 1504 can be configured to perform various actions. In some embodiments, the cache 1508 may include multiple types of cache including, for example, level one (L1) and level two (L2) cache. The memory 1514 may be referred to herein as system memory or computer system memory. The memory 1514 may include, at various times, elements of an operating system, one or more applications, data associated with the operating system or the one or more applications, or other such data associated with the computing device 1502.

Other system memory 1514 can be available for use as well. The memory 1514 can include multiple different types of memory with different performance characteristics. The processor 1504 can include any general purpose processor and one or more hardware or software services, such as service 1512 stored in storage device 1510, configured to control the processor 1504 as well as a special-purpose processor where software instructions are incorporated into the actual processor design. The processor 1504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1504 can be a microprocessor, a microcontroller, a digital signal processor (“DSP”), or a combination of these and/or other types of processors. In some embodiments, the processor 1504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1500, an input device 1516 can represent any number of input mechanisms, such as a microphone for speech, a touch-sensitive screen for gesture or graphical input, keyboard, mouse, motion input, pen, and other such input devices. An output device 1518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1500. In some embodiments, the input device 1516 and/or the output device 1518 can be coupled to the computing device 1502 using a remote connection device such as, for example, a communication interface such as the network interface 1520 described herein. In such embodiments, the communication interface can govern and manage the input and output received from the attached input device 1516 and/or output device 1518. As may be contemplated, there is no restriction on operating on any particular hardware arrangement and accordingly the basic features here may easily be substituted for other hardware, software, or firmware arrangements as they are developed.

In some embodiments, the storage device 1510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1510 can include hardware and/or software services such as service 1512 that can control or configure the processor 1504 to perform one or more functions including, but not limited to, the methods, processes, functions, systems, and services described herein in various embodiments. In some embodiments, the hardware or software services can be implemented as modules. As illustrated in example computing system architecture 1500, the storage device 1510 can be connected to other parts of the computing device 1502 using the system connection 1506. In an embodiment, a hardware service or hardware module such as service 1512, that performs a function can include a software component stored in a non-transitory computer-readable medium that, in connection with the necessary hardware components, such as the processor 1504, connection 1506, cache 1508, storage device 1510, memory 1514, input device 1516, output device 1518, and so forth, can carry out the functions such as those described herein.

The disclosed processed for generating and executing experience recommendations can be performed using a computing system such as the example computing system illustrated in FIG. 15, using one or more components of the example computing system architecture 1500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1504 wherein the code is stored in memory such as memory 1514 as described herein. One or more of a user device, a provider server or system, a database system, or other such devices, services, or systems may include some or all of the components of the computing system such as the example computing system illustrated in FIG. 15, using one or more components of the example computing system architecture 1500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1514 can be coupled to the processor 1504 by, for example, a connector such as connector 1506, or a bus. As used herein, a connector or bus such as connector 1506 is a communications system that transfers data between components within the computing device 1502 and may, in some embodiments, be used to transfer data between computing devices. The connector 1506 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1514 can also include magnetic or optical data storage media including read-only (e.g., CD ROM and DVD ROM) or otherwise (e.g., CD or DVD). The memory can be local, remote, or distributed.

As described above, the connector 1506 (or bus) can also couple the processor 1504 to the storage device 1510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1506 can also couple the processor 1504 to a network interface device such as the network interface 1520. The interface can include one or more of a modem or other such network interfaces including, but not limited to those described herein. It will be appreciated that the network interface 1520 may be considered to be part of the computing device 1502 or may be separate from the computing device 1502. The network interface 1520 can include one or more of an analog modem, Integrated Services Digital Network (ISDN) modem, cable modem, token ring interface, satellite transmission interface, or other interfaces for coupling a computer system to other computer systems. In some embodiments, the network interface 1520 can include one or more input and/or output (I/O) devices. The I/O devices can include, by way of example but not limitation, input devices such as input device 1516 and/or output devices such as output device 1518. For example, the network interface 1520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1502 can be connected to one or more additional computing devices such as computing device 1524 via a network 1522 using a connection such as the network interface 1520. In such embodiments, the computing device 1524 may execute one or more services 1526 to perform one or more functions under the control of, or on behalf of, programs and/or services operating on computing device 1502. In some embodiments, a computing device such as computing device 1524 may include one or more of the types of components as described in connection with computing device 1502 including, but not limited to, a processor such as processor 1504, a connection such as connection 1506, a cache such as cache 1508, a storage device such as storage device 1510, memory such as memory 1514, an input device such as input device 1516, and an output device such as output device 1518. In such embodiments, the computing device 1524 can carry out the functions such as those described herein in connection with computing device 1502. In some embodiments, the computing device 1502 can be connected to a plurality of computing devices such as computing device 1524, each of which may also be connected to a plurality of computing devices such as computing device 1524. Such an embodiment may be referred to herein as a distributed computing environment.

The network 1522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1522 can be wired connections, wireless connections, or combinations thereof. Communications via the network 1522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1522, within the computing device 1502, within the computing device 1524, or within the computing resources provider 1528 can include information, which also may be referred to herein as content. The information may include text, graphics, audio, video, haptics, and/or any other information that can be provided to a user of the computing device such as the computing device 1502. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1502 and presented to a user of the computing device 1502 using forms that are perceptible via sight, sound, smell, taste, touch, or other such mechanisms. In some embodiments, communications over the network 1522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1502 and/or the computing device 1524 can be connected to a computing resources provider 1528 via the network 1522 using a network interface such as those described herein (e.g. network interface 1520). In such embodiments, one or more systems (e.g., service 1530 and service 1532) hosted within the computing resources provider 1528 (also referred to herein as within “a computing resources provider environment”) may execute one or more services to perform one or more functions under the control of, or on behalf of, programs and/or services operating on computing device 1502 and/or computing device 1524. Systems such as service 1530 and service 1532 may include one or more computing devices such as those described herein to execute computer code to perform the one or more functions under the control of, or on behalf of, programs and/or services operating on computing device 1502 and/or computing device 1524.

For example, the computing resources provider 1528 may provide a service, operating on service 1530 to store data for the computing device 1502 when, for example, the amount of data that the computing device 1502 exceeds the capacity of storage device 1510. In another example, the computing resources provider 1528 may provide a service to first instantiate a virtual machine (VM) on service 1532, use that VM to access the data stored on service 1532, perform one or more operations on that data, and provide a result of those one or more operations to the computing device 1502. Such operations (e.g., data storage and VM instantiation) may be referred to herein as operating “in the cloud,” “within a cloud computing environment,” or “within a hosted virtual machine environment,” and the computing resources provider 1528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1530 and service 1532 may implement versions of various services (e.g., the service 1512 or the service 1526) on behalf of, or under the control of, computing device 1502 and/or computing device 1524. Such implemented versions of various services may involve one or more virtualization techniques so that, for example, it may appear to a user of computing device 1502 that the service 1512 is executing on the computing device 1502 when the service is executing on, for example, service 1530. As may also be contemplated, the various services operating within the computing resources provider 1528 environment may be distributed among various systems within the environment as well as partially distributed onto computing device 1524 and/or computing device 1502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
detecting access to a website, wherein the access to the website is associated with a user;
identifying one or more contextual signals, wherein the one or more contextual signals are identified based on content presented on the website and data associated with the user;
obtaining product information associated with one or more products;
generating contextual information using the one or more contextual signals and the product information, wherein the contextual information includes one or more messages corresponding to the one or more contextual signals and the product information;
generating a gift advertisement, wherein the gift advertisement is generated using the product information and the contextual information, and wherein the gift advertisement includes the one or more messages and a link to a page for generating a gift from the one or more products; and
presenting the gift advertisement, wherein when the user selects the gift advertisement, the user is redirected to the page to present one or more options for generating the gift from the one or more products, and wherein the one or more options are generated based on the one or more contextual signals and the contextual information.

2. The computer-implemented method of claim 1, wherein the page is a product detail page associated with the one or more products, and wherein the product detail page is provided by a retailer that makes available the one or more products.

3. The computer-implemented method of claim 1, wherein the one or more options include a set of delivery options for the gift, and wherein the set of delivery options are identified based on the one or more contextual signals.

4. The computer-implemented method of claim 1, wherein the product information includes images of the one or more products, pricing details of the one or more products, and customization options associated with the one or more products.

5. The computer-implemented method of claim 1, wherein the contextual signals are associated with an event date, and wherein the contextual information incorporates the event date.

6. The computer-implemented method of claim 1, wherein the contextual signals include clickstream data associated with the user, search data associated with the user, purchase data associated with the user, and user profile data associated with the user.

7. The computer-implemented method of claim 1, wherein the contextual signals are obtained through a cookie implemented on a user device associated with the user.

8. A system, comprising:
one or more processors; and
memory storing thereon instructions that, as a result of being executed by the one or more processors, cause the system to:
detect access to a website, wherein the access to the website is associated with a user;
identify one or more contextual signals, wherein the one or more contextual signals are identified based on content presented on the website and data associated with the user;
obtain product information associated with one or more products;
generate contextual information using the one or more contextual signals and the product information, wherein the contextual information includes one or more messages corresponding to the one or more contextual signals and the product information;
generate a gift advertisement, wherein the gift advertisement is generated using the product information and the contextual information, and wherein the gift advertisement includes the one or more messages and a link to a page for generating a gift from the one or more products; and
present the gift advertisement, wherein when the user selects the gift advertisement, the user is redirected to the page to present one or more options for generating the gift from the one or more products, and wherein the one or more options are generated based on the one or more contextual signals and the contextual information.

9. The system of claim 8, wherein the page is a product detail page associated with the one or more products, and wherein the product detail page is provided by a retailer that makes available the one or more products.

10. The system of claim 8, wherein the one or more options include a set of delivery options for the gift, and wherein the set of delivery options are identified based on the one or more contextual signals.

11. The system of claim 8, wherein the product information includes images of the one or more products, pricing details of the one or more products, and customization options associated with the one or more products.

12. The system of claim 8, wherein the contextual signals are associated with an event date, and wherein the contextual information incorporates the event date.

13. The system of claim 8, wherein the contextual signals include clickstream data associated with the user, search data associated with the user, purchase data associated with the user, and user profile data associated with the user.

14. The system of claim 8, wherein the contextual signals are obtained through a cookie implemented on a user device associated with the user.

15. A non-transitory, computer-readable storage medium storing thereon executable instructions that, as a result of being executed by a computer system, cause the computer system to:
detect access to a website, wherein the access to the website is associated with a user;
identify one or more contextual signals, wherein the one or more contextual signals are identified based on content presented on the website and data associated with the user;
obtain product information associated with one or more products;
generate contextual information using the one or more contextual signals and the product information, wherein the contextual information includes one or more messages corresponding to the one or more contextual signals and the product information;
generate a gift advertisement, wherein the gift advertisement is generated using the product information and the contextual information, and wherein the gift advertisement includes the one or more messages and a link to a page for generating a gift from the one or more products; and
present the gift advertisement, wherein when the user selects the gift advertisement, the user is redirected to the page to present one or more options for generating the gift from the one or more products, and wherein the one or more options are generated based on the one or more contextual signals and the contextual information.

16. The non-transitory, computer-readable storage medium of claim 15, wherein the page is a product detail page associated with the one or more products, and wherein the product detail page is provided by a retailer that makes available the one or more products.

17. The non-transitory, computer-readable storage medium of claim 15, wherein the one or more options include a set of delivery options for the gift, and wherein the set of delivery options are identified based on the one or more contextual signals.

18. The non-transitory, computer-readable storage medium of claim 15, wherein the product information includes images of the one or more products, pricing details of the one or more products, and customization options associated with the one or more products.

19. The non-transitory, computer-readable storage medium of claim 15, wherein the contextual signals are associated with an event date, and wherein the contextual information incorporates the event date.

20. The non-transitory, computer-readable storage medium of claim 15, wherein the contextual signals include clickstream data associated with the user, search data associated with the user, purchase data associated with the user, and user profile data associated with the user.

21. The non-transitory, computer-readable storage medium of claim 15, wherein the contextual signals are obtained through a cookie implemented on a user device associated with the user.
